(19) United States
(12) Patent Application Publication
(10) Pub. No.: US 2012/0189259 A1
(43) Pub. Date: Jul. 26, 2012

(54) PRE-TERMINATED FIBER DEVICES, SYSTEMS, AND METHODS

(75) Inventor: Dennis Manes, Mill Creek, WA (US)

(73) Assignee: LEVITON MANUFACTURING CO., INC., Melville, NY (US)

(21) Appl. No.: 13/326,913

(22) Filed: Dec. 15, 2011

Related U.S. Application Data
(60) Provisional application No. 61/423,546, filed on Dec. 15, 2010.
(60) Provisional application No. 61/448,452, filed on Mar. 2, 2011.

(51) Int. Cl. G02B 6/46

(52) U.S. Cl. 385/135; 29/407.1

(57) ABSTRACT

The disclosed subject matter provides for pre-terminated fiber optic connector devices, systems, and methods for coupling in a high speed telecommunications networked environment. A multi-fiber optical cable assembly or multi-fiber interconnection module can facilitate optical coupling while preserving path polarity. In an embodiment, a 2×12/12 to 3×8/12 configuration can be employed. In another embodiment a 1×24/24 to 3×8/12 configuration can be employed.

### CROSS-REFERENCE TO RELATED APPLICATIONS

### Related Applications

This application claims the benefit of U.S. Provisional Application No. 61/423,546, “OPTICAL FIBER WIRING AND CORRESPONDING APPARATUS,” filed 15 Dec. 2010, which is hereby incorporated by reference in its entirety. This application further claims the benefit of U.S. Provisional Application No. 61/448,452, “PRE-TERMINATED FIBER DEVICES, SYSTEMS, AND METHODS,” filed 02 Mar. 2011, which is also hereby incorporated by reference in its entirety.

### TECHNICAL FIELD

The disclosed subject matter relates to communicatively coupling electronic, fiber optic and optoelectronic components and, more particularly, to coupling multi-path electronic, fiber optic and optoelectronic components by way of multi-fiber optical component(s) and/or technique(s).

### BACKGROUND

Conventional fiber optic cables comprise one or more optical fibers to conduct light. Modulation of the light can encode information or signals. Thus, light transmitted across fiber optic cables can communicatively couple electronic, fiber optic and optoelectronic components. The volume of information that can be communicated across fiber optic cables typically far exceeds the volume in a corresponding copper core electrical cable. Examples of data communication over fiber optic cables include the transmission of large quantities of voice information over telephone system fiber optic cables, data transmission over fiber optic internet backbone cables, etc.

Increasingly, fiber optic cables are being employed in more granular applications, such as local area networks employing optical transceivers, corporate intranets deploying optical pathways for high-speed transmission of data on a corporate campus, etc. Standards and guidelines have emerged to help direct the adoption of fiber optic related cabling and components at these more granular levels. As an example of these guidelines, the Telecommunications Industry Association/Electronic Industries Alliance guidelines, TIA/EIA-568-B.1 Addendum 7, “Guidelines for Maintaining Polarity Using Array Connectors,” outlines three recommended methods (method A, B and C) for assuring correct transmit-to-receive polarity over serial duplex fiber circuits using ribbon cables and array connectors.

Adoption of particular standards or adherence to guidelines can result in reliance on said standard or guidelines and difficulty in incorporating or adopting elements from other standards or guidelines. As an example, incorporating fiber optic cabling from the aforementioned TIA/EIA-568 guidelines includes a suggestion that intermixing cabling components from methods A, B, and/or C may result in incorrect polarity. These types of limitations can impact transitioning a system employing optical components as the system evolves over time.

The above-described deficiencies of conventional fiber optic cabling, systems, and methods is merely intended to provide an overview of some of the problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments relate to optical coupling in optical network environments. In an embodiment, a fiber optic cable assembly can include a multi-fiber optical cable consisting of a plurality of channels, each channel comprising at least four optical fibers. The optical cable can be installed into at least one multi-fiber optical connector at one end. A second group of multi-fiber optical connectors can have the second end of the optical cable installed therein. Channels are not split across multi-fiber optical connectors of the second group.

In another embodiment, a multi-fiber interconnection module can include a plurality of channels wherein each channel comprises at least four optical fibers. The multi-fiber interconnection module can include at least a first multi-fiber optical connector in which the optical fibers of at least one channel are installed. The multi-fiber interconnection module can further include a plurality of other multi-fiber optical connectors each having the optical fibers of at least one channel installed therein.

In a further embodiment, a method comprises identifying each of a plurality of optical fibers forming a plurality of channels wherein each channel comprises four optical fibers. The method then comprises selecting a first quantity of multi-fiber optical connectors in which to install a first end of the optical fibers. The sum of the optical pathways of the first quantity should be the same as the count of optical fibers. A second quantity of multi-fiber optical connectors can then be selected in which to install the second end of the optical fibers. The sum of the optical pathways of the second quantity should be greater than the count of optical fibers. The method then describes installing the first end of the optical fibers of a channel in one of the first quantity of multi-fiber optical connectors, followed by installing the second end of the optical fibers of a channel in one of the second quantity of multi-fiber optical connectors.

In another example embodiment, a system includes a plurality of optical fibers. The fibers comprise channels each having four optical fibers. The multi-fiber interconnection module can include at least a first multi-fiber optical connector in which the optical fibers of at least one channel are installed. The multi-fiber interconnection module can further include a plurality of other multi-fiber optical connectors each having the optical fibers of at least two channels installed therein.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed.

Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is an illustration of systems that facilitate optical coupling in accordance with aspects of the subject disclosure.

FIG. 2 is a depiction of a system that facilitates optical coupling in accordance with aspects of the subject disclosure.

FIG. 3 illustrates a system that facilitates optical coupling in accordance with aspects of the subject disclosure.

FIG. 4 is an illustration of interconnection modules that facilitate optical coupling in accordance with aspects of the subject disclosure.

FIG. 5 is a depiction of fiber optic cable assemblies that facilitate optical coupling in accordance with aspects of the subject disclosure.

FIG. 6-8 are depictions of optical fiber groupings that facilitate optical coupling in accordance with aspects of the subject disclosure.

FIG. 9-11 are depictions of core side optical fiber layout schematics that facilitate optical coupling in accordance with aspects of the subject disclosure.

FIG. 12-14 are depictions of edge side optical fiber layout schematics that facilitate optical coupling in accordance with aspects of the subject disclosure.

FIG. 15 is a depiction of a core side optical fiber layout schematic that facilitates optical coupling in accordance with aspects of the subject disclosure.

FIG. 16 illustrates an edge side optical fiber layout schematic that facilitates optical coupling in accordance with aspects of the subject disclosure.

FIG. 17 illustrates a method for assembling a fiber optic component in accordance with aspects of the subject disclosure.

FIG. 18 illustrates a method for assembling a fiber optic component in accordance with aspects of the subject disclosure.

FIG. 19 is a block diagram of exemplary environments in which to implement and exploit various features or aspects of the subject disclosure.

FIG. 20 illustrates a block diagram of a computing system operable to execute the disclosed systems and methods in accordance with an embodiment.

### DETAILED DESCRIPTION

The presently disclosed subject matter illustrates optical coupling devices, systems, and methods. More particularly, optical coupling devices, systems and methods employing multiple optical communication pathways are disclosed. Multi-fiber optical cables can be used to pipe light in multi-path optical systems.

Multi-fiber optical cables can be terminated with multi-fiber connectors. Multiple fiber connectors have evolved, and continue to do so, since the inception of fiber optic cabling. One contemporary multi-fiber optical connector is the Multi-fiber Push on/Pull off (MPO) connector. A similar multi-fiber optical connector is the Multi-fiber Terminator Push on/Pull off (MPT) connector. It should be noted that while these terms may be used in the following description, they are not meant to be used in a limiting manner and any other suitable multi-fiber connector could be substituted where MPT/MPO connectors are disclosed, unless explicitly stated otherwise.

MPT/MPO connectors have become widely accepted for their ease of use, reliability, and low losses for multi-fiber optical coupling. MPT/MPO connectors can come in numerous fiber/path configurations and keyed to provide polarity when connecting the MPT/MPO with other components. Popular MPT/MPO configurations include 2-fiber/path and 12-fiber/path configurations. Moreover, configurations that employ multiples of 12-fiber/path configurations appear to be gaining traction and can include a 12-fiber/path connector and a 24-fiber/path connector. A 12-fiber/path MPT/MPO connector can arrange the 12 optical paths in a linear layout such that subsequent optical paths are linearly arranged. Optical fiber would then typically be set in each of the 12 optical paths, bonded in place, and polished to provide a suitable mating surface to facilitate optical coupling with a component designed to receive the MPT/MPO connector. Similarly, a 24-fiber MPT/MPO connector can arrange the 24 optical paths in two rows of twelve optical paths arranged in a generally rectangular pattern. It will be noted that other alternate layout geometries can be employed without departing from the scope of the present disclosure. For ease of discussion and clarity, the present disclosure can be discussed in terms of 12-fiber/path and 24-fiber/path MPT/MPO connectors, though it is explicitly not so limited. It will be noted that other qualities of optical fibers/paths, or other styles of connector, can be employed without departing from the scope of the present disclosure.

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

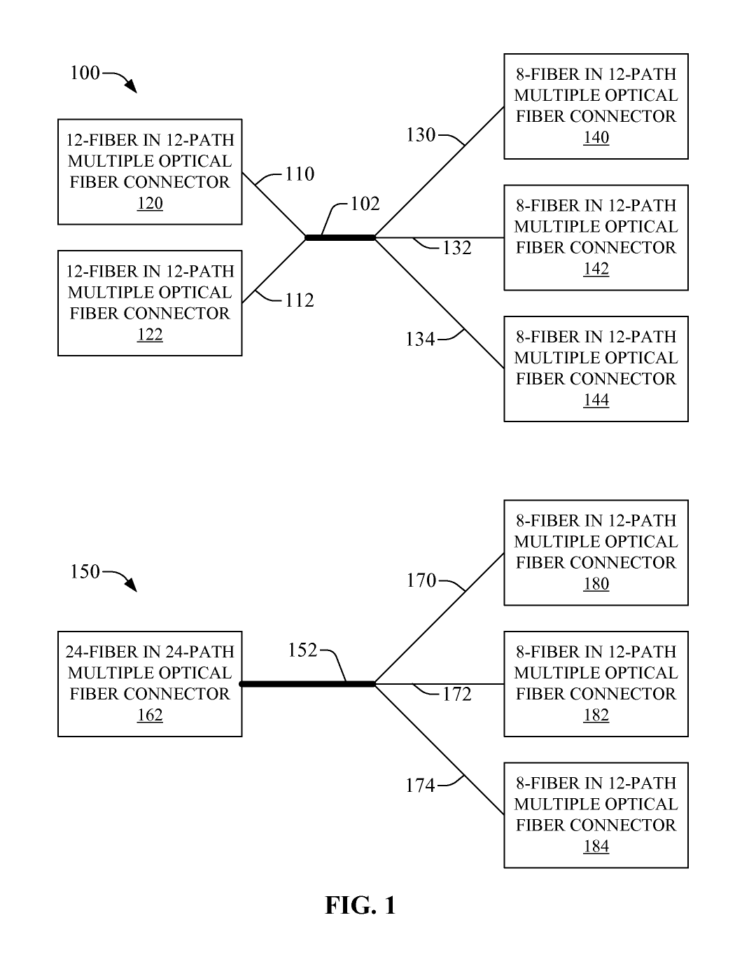

FIG. 1 is an illustration of systems 100 and 150, which facilitate optical coupling in accordance with aspects of the subject disclosure. System 100 can include a multi-fiber optical fiber cable 102. Where, for example, multi-fiber optical cable 102 comprises 24 optical fibers, these fibers can be evenly bunched into two groups of 12 fibers, 110 and 112 at one end of cable 102, and three groups of 8 fibers, 130, 132, and 134, at the other end of cable 102. Similarly, system 150 can include a multi-fiber cable 152. Where, as with the prior example, cable 152 comprises 24 optical fibers, these fibers can be bunched into a single group of 24 fibers at one end and three groups of 8 fibers, 170, 172, and 174, at the other end of cable 152. Of note, some permutations of the presently disclosed subject matter can include multi-fiber optical cables, e.g., 102 and 152, having other numbers of fibers, having fibers that are not included in bunching, etc., without departing from the scope of the presently disclosed subject matter. As an example, a multi-fiber optical cable can include 27 optical fibers and be bunched into two groups of 12 at one end and three groups of 8 at the other with 3 optical fibers left unbunched, or bunched with another optical cable's fibers, at either end. Of note, these three optical fibers can be, but need not be, inserted into a connector at either end of the optical cable, e.g., 102 or 152.

Systems 100 and 150 can further include one or more multi-path optical connectors. In system 100, exemplary 24-fiber optical cable 102, for example, can be bunched into two bundles of 12 fibers, 110 and 112, at one end. Bunch 110 can be installed in a multi-path optical fiber connector, for example, 12-path multiple optical fiber connector 120. Furthermore, where the exemplary installed bundle 110 includes 12 fibers, connector 120 can be a 12 fiber in 12 path multiple optical fiber connector as illustrated. Similarly, 12 fiber in 12 path multiple optical fiber connector 122 can have exemplary bundle 112, e.g., 12 fibers, installed therein in a similar manner. In system 150, connector 162 can be, for example, a 24-path multiple optical fiber connector. Thus, where exemplary optical cable 152 has 24 optical fibers, these can be installed in connector 162 in a manner similar to that described for connectors 120 and 122 of system 100.

| Fiber Identity | Output | Output | Output |
|---|---|---|---|
| and Input | Connector | Connector | Connector |
| Connector | Position, | Position, | Position, |
| Position | Method A | Method B | Method C |
| 1 | 1 | 12 | 2 |
| 2 | 2 | 11 | 1 |
| 3 | 3 | 10 | 4 |
| 4 | 4 | 9 | 3 |
| 5 | 5 | 8 | 6 |
| 6 | 6 | 7 | 5 |
| 7 | 7 | 6 | 8 |
| 8 | 8 | 5 | 7 |
| 9 | 9 | 4 | 10 |
| 10 | 10 | 3 | 9 |
| 11 | 11 | 2 | 12 |
| 12 | 12 | 1 | 11 |

Table 1 shows exemplary mapping of optical fibers in a multi-fiber optical cable installed into an input and output multi-fiber optical fiber connector for each of three different exemplary methods, Method A, B and C.

Installation of optical fibers in multi-fiber optical connectors can be associated with identifying each individual fiber and installing it in a predetermined path of a multi-fiber connector. The particular mapping of an optical fiber associated with a particular identifier, such as color or relative position in a ribbon cable, can be prescribed by accepted industry standards such that users familiar with the given standard applied to a mapping can employ an optical cable assembly or optical cable module of a given standard in the appropriate manner. As an example, a particular color can be associated with a fiber that is always installed in a first position of a connector. As a more complex example, Table 1 describes the relationship between input fiber position within a multi-fiber optical connector and the position of the same fibers in an output fiber position within a multi-fiber connector in general accordance with TIA/EIA-568 guidelines.

In an aspect, connectors 120 and 122 can be keyed to provide for polarity in optical coupling. Using the TIA/EIA-568 guidelines as an example, without a keyed multi-fiber optical connector, installation of a Method A output connector, e.g., fiber 1 to 12 correspondingly installed into output positions 1 to 12, can easily be confused with a Method B output connector simply by inserting the Method A connector into a receiving port upside down. However, where the output connector and port are keyed to allow insertion in only one orientation, the Method A connector cannot be accidentally inserted upside down and the polarity of the fiber positions is maintained. Similarly, connectors 140, 142, 144, 162, 180, 182, and 184 can be keyed to provide polarity retention.

System 100 can further include multi-fiber optical fiber connector 140. Connector 140, for example, can be a 12-path multiple optical fiber connector as illustrated. Whereas exemplary bunch 130 comprises 8 optical fibers, these fibers can be installed in connector 140 to result in an 8 fiber in 12 path multiple optical fiber connector. As previously disclosed, the particular fiber installation layout can be predetermined such that particular identified optical fibers are installed in particular path positions within a connector such as connector 140. Whereas an 8 fiber in 12 path connector designates only eight paths as installed with fiber, four paths can remain uninstalled or empty. As an example, Table 2 illustrates some possible fiber layouts generally in accord with the TIA/EIA-568 guidelines in a manner similar to that disclosed in Table 1.

In a further aspect, empty paths for connectors installed on one end of a multi-fiber optical cable need not be associated with empty paths for connectors installed on the distal end of the multi-fiber optical cable. Where, as in exemplary system 100, three 8 fiber in 12 path connectors, e.g., 140, 142, and 144, are each installed on an exemplary 8 fiber bundle, e.g., 130, 132, and 134, each can have 4 empty path positions. This can also be viewed as having 24 fibers installed across 36 paths in three connectors. The distal end of optical cable 102 can have these 24 fibers installed in connectors either with or without empty path positions, such as installing the exemplary 24 fibers of optical cable 102 into two 12-path connectors, e.g., 120 and 122.

| Fiber Identity | Output | Output | Output |
|---|---|---|---|
| and Input | Connector | Connector | Connector |
| Connector | Position, | Position, | Position, |
| Position | Method A | Method B | Method C |
| 1 | 1 | 12 | 2 |
| 2 | 2 | 11 | 1 |
| 3 | 3 | 10 | 4 |
| 4 | 4 | 9 | 3 |
| Empty | empty | empty | empty |
| Empty | empty | empty | empty |
| Empty | empty | empty | empty |
| Empty | empty | empty | empty |
| 9 | 9 | 4 | 10 |
| 10 | 10 | 3 | 9 |
| 11 | 11 | 2 | 12 |
| 12 | 12 | 1 | 11 |

Table 2 shows exemplary mapping of a bundle of 8 optical fibers of a multi-fiber optical cable installed into an input and output multi-fiber optical fiber connector for each of three different exemplary methods, Method A, B and C.

Of note, cable assembly or module configurations having full connectors on a first end and empty path positions on a second end of an optical cable can be desirable for many reasons. As a non-limiting example, as in system 100, industry standard 12 path connectors can be employed eliminating the need to employ two types of connectors in a system. As a second non-limiting example, future expansion can be accommodated by such configurations. Where only 8 fibers may be used to meet instant bandwidth needs, the use of a 12-position connector can allow the addition of 4 additional fibers for future expansion by simply replacing the cable assembly or module with a higher fiber count assembly or module.

| Fiber Identity | Connector | Connector | Connector |
|---|---|---|---|
| and Connector | Position, | Position, | Position, |
| Position, | Connector | Connector | Connector |
| Connector 162 | 184 | 182 | 180 |
| 1 | empty | 1 | empty |
| 2 | empty | 2 | empty |
| 3 | empty | 3 | empty |
| 4 | empty | 4 | empty |
| 5 | 9 | empty | empty |
| 6 | 10 | empty | empty |
| 7 | 11 | empty | empty |
| 8 | 12 | empty | empty |
| 9 | 1 | empty | empty |
| 10 | 2 | empty | empty |
| 11 | 3 | empty | empty |
| 12 | 4 | empty | empty |
| 13 | empty | empty | 9 |
| 14 | empty | empty | 10 |
| 15 | empty | empty | 11 |
| 16 | empty | empty | 12 |
| 17 | empty | empty | 1 |
| 18 | empty | empty | 2 |
| 19 | empty | empty | 3 |
| 20 | empty | empty | 4 |
| 21 | empty | 9 | empty |
| 22 | empty | 10 | empty |
| 23 | empty | 11 | empty |
| 24 | empty | 12 | empty |

Table 3 shows exemplary mapping of 24 fibers from a 24-path connector, Connector 162, to three bundles of 8 optical fibers, each bundle installed on a 12 path connector, Connector 180, 182, and 184. Of note, “empty” can indicate either an empty path or a non-existent position in a connector, wherein connector 162 is a 24 position connector and each of connectors 180, 182, and 184 are 12 position connectors.

Table 3 illustrates mapping of a 24 fiber in 24 path multiple optical fiber connector, e.g., connector 162, to three 8 fiber in 12 path connectors, e.g., connectors 180, 182, and 184. A higher density of optical fibers occurs in connector 162 than the other three connectors, 180, 182, and 184. Assuming that connector 162 is optically coupled at a trunk cable having additional fibers available, to increase bandwidth to electronic, fiber optic and optoelectronic devices connected to connectors 180-184, all that would be needed is to replace the illustrated optical cable assembly with a cable assembly having fewer empty positions. That is, where the trunk, e.g., core side component, may have several thousand fibers available, and an edge side component can have a 12-path optical port using only 8 paths, changing cable assemblies to employ more of the 12 ports is a generally desirable bandwidth upgrade route compared to having started with an 8-path optical port on the edge side component in which all paths are full and then upgrading the entire component when more bandwidth is needed. Of note, Table 3 would similarly illustrate mapping of a 24 fiber in 24 path multiple optical fiber connector, e.g., connector 162, to three 8 fiber in 24 path connectors that are not illustrated for brevity and clarity but which would be well within the scope of the present disclosure.

Further, Table 3 illustrates that a single 24 fiber in 24 path connector, e.g., connector 162, can serve fiber distributed to three 8 fiber in 12 path connectors, e.g., 180-184, in a manner similar to that of using three individual cable assemblies (not illustrated) with 8 fiber in 12 path connectors on each end. It should be noted that the majority of space occupied by an optical connector is not consumed by the optical fiber itself. As such, 24 individual fiber connectors would typically have a substantially larger sum footprint than a single multi-fiber optical connector having 24 optical fibers. Thus, by employing an asymmetric quantity of connectors on each end of an optical cable, e.g., 102 and 152, a corresponding reduction in consumed footprint can be achieved. As an example, system 100 can consume less footprint with connectors 120 and 122 than a corresponding conventional cable assembly having three individual cable assemblies (not illustrated) terminated in 12-path optical connectors despite only generally employing 8 of the 12 optical paths. Similarly, system 150 can consume less footprint than system 100 by employing a single 24-path optical connector, e.g., 162, rather than two 12-path optical connectors, e.g., 120 and 122, to achieve the same fan out to three 8 fiber in 12 path optical connectors, e.g., 180-184 and 140-144 correspondingly.

In a further aspect, multi-fiber systems such as system 100 and 150 can be embodied in multi-fiber optical cable assemblies (MOCAs) or multi-fiber interconnection modules (MIMs). A MOCA can include an optical cable, e.g., 102 and 152, installed in multi-fiber connectors, e.g., 120, 122, 140-144, 162, and 180-184. A MOCA can further include strain relief, protective sheathing, boots, end covers/caps, color-coding or other identifiers of cable assembly type, etc.

A MIM can also include an optical cable, e.g., 102 and 152, installed in multi-fiber connectors, e.g., 120, 122, 140-144, 162, and 180-184. However, a MIM will typically encase these components in a housing, block of material, etc. As an example, a MIM can be a MOCA mounted within a walled enclosure providing access to the connectors, to allow optical coupling of the fibers, while also limiting access to the remainder of the components within the walled enclosure. MIMs can be embodied as fiber optic cassettes. Another example of a MIM can include casting the optical cable and installed connectors in a block of material, such as an epoxy, plastic, aerogel, urethane, etc. This type of MIM can provide access to the connectors in a manner similar to a walled enclosure but can do so without “walls.” In an aspect, a cast-type MIM can be formed on a fixture and reduce the need for assembly of individual parts that can be associated with installing optical module components in a walled enclosure. The cast-type MIM is simply formed in an appropriate manner around the optical fibers and connectors as compared to having to manually place the optical fibers and connectors mechanically into the walls and support structures of a walled enclosure.

Cast-type MIMs can further include layered cast materials. As an example, an optical fiber assembly can first be cast in a low-weight urethane foam module. This urethane foam core can then be cast in an elastomeric coating material to provide additional protection to the MIM. The resulting two-layer core can then be cast in a hard thermoplastic module to provide mechanical attachment assemblies, such as holes to bolt the module into a rack mount, etc. It will be noted that any number of layers and materials can be employed in cast-type MIMs without departing from the instant disclosure. It will further be appreciated that the layers and materials can be of any appropriate geometry to provide the desired properties of the MIM. For example, a ruggedized MIM can have a thicker elastomeric layer than a non-ruggedized MIM while still having similar external dimensions. Continuing the preceding example, this can be achieved by employing a smaller urethane casting or a thinner thermoplastic casting for the ruggedized MIM to leave more space for a correspondingly thicker elastomeric layer than would be employed in the non-ruggedized MIM.

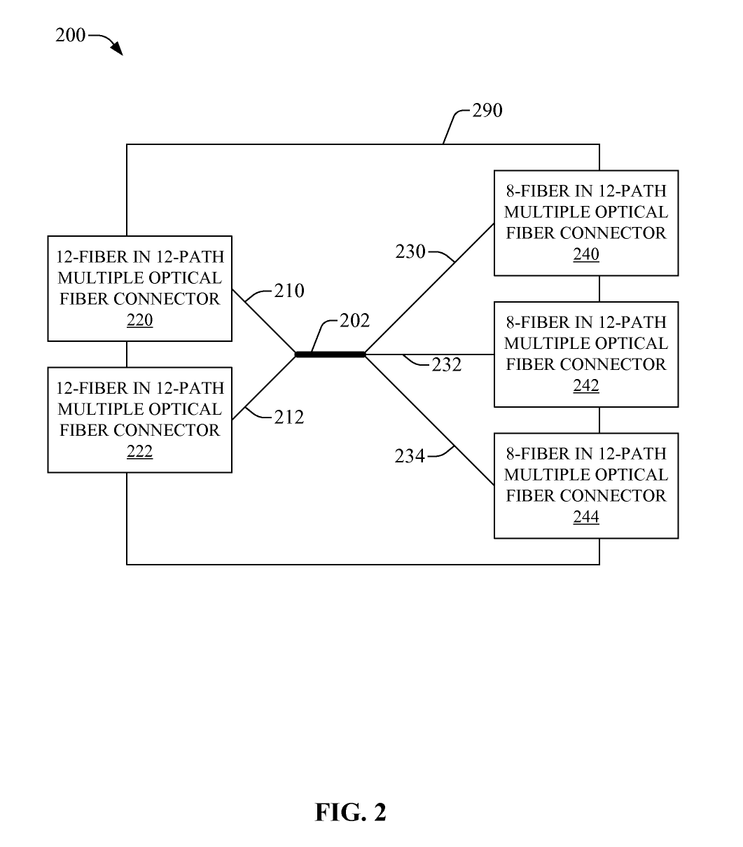

FIG. 2 is a depiction of a system 200, which can facilitate optical coupling in accordance with aspects of the subject disclosure. System 200 can include a multi-fiber optical cable 202. Multi-fiber optical cable 202 can comprise a plurality of individual optical fibers, for example, 24 optical fibers. These fibers can be evenly bunched, for example, into two groups of 12 fibers, 210 and 212 at a first end of cable 202, and three groups of 8 fibers, 230, 232, and 234 at a second end of cable 202. In an aspect, multi-fiber optical cables 202 can comprise other numbers of optical fibers without departing from the scope of the presently disclosed subject matter. In a further aspect, bunching of the plurality of optical fibers can be in any number of groups at the first and second ends of cable 202. Furthermore, these numbers of groups can be different at the first end and second end, for example, for an optical cable having 24 optical fibers, a first end having four bunches of 6 fibers and the second end having six bunches of 4 fibers, etc.

System 200 can further include an enclosure 290. Enclosure 290 can be a walled enclosure or a cast enclosure as disclosed elsewhere herein. The several multiple optical fiber connectors, e.g., 220, 222, and 240-244, terminating the bunches of optical fibers, e.g., 210, 212, and 230-234, can be integrated with enclosure 290. The integration of connectors 220, 222, and 240-244 can be permanent, semi-permanent, or non-permanent. Furthermore, the integration of connectors 220, 222, and 240-244 in a walled enclosure can be by mechanical means including removable fasteners such as screws; non-removable fasteners such as rivets; permanent or removable structures such as snap-in bezels, retaining clips, or friction mounts; regions of mechanical entrapment; fusing of materials such as hypersonic welding of materials; adhesives such as glues or epoxies; etc. The integration of connectors 220, 222, and 240-244 in a cast enclosure can include those of the walled enclosure and, in addition, can include bonding between a casting material and the connector material, conformal mechanical entrapment of the connector in a casting material, etc.

Enclosure 290 can house the remaining components of system 200 such that optical coupling can occur at a connector, e.g., connector 220, 222, and 240-244. Connector 220, 222, and 240-244 can terminate the bunched ends of optical cable 202, e.g., 210, 212, and 230-234, by having the individual optical fibers installed in the connectors as disclosed elsewhere herein. As an example, where optical cable 202 includes 24 individual fibers bunched so that bunch 210 includes 12 fibers, bunch 212 includes 12 fibers, bunch 230 includes 8 fibers, bunch 232 includes 8 fibers, and bunch 234 includes 8 fibers, installation of the bunches in connectors can result in 12 fiber in 12 path multiple fiber optical connector 220, 12 fiber in 12 path multiple fiber optical connector 222, 8 fiber in 12 path multiple fiber optical connector 240, 8 fiber in 12 path multiple fiber optical connector 242, and 8 fiber in 12 path multiple fiber optical connector 244.

Whereas system 200 can include enclosure 290, system 200 can represent an example of a MIM as disclosed elsewhere herein. MIMs can be of a repeatable unit size allowing for the rapid replacement of MIMs with other MIMs having the same or different characteristics. As an example, a first MIM can fail. This first MIM can be replaced by unplugging the several optical connections made with connectors, such as connectors 220, 222, and 240-244, removing the first MIM, replacing the first MIM with a second MIM and reconnecting the several optical connections in a like manner. Similarly, for example, a MIM can be upgraded by swapping a first MIM for an improved MIM.

System 200 can illustrate a “2×12/12 to 3×8/12” MIM, e.g., the MIM includes two 12 fiber in 12 path optical connectors 220 and 222 connected by a multi-fiber optical cable to three 8 fiber in 12 path optical connectors 240-244. Installation of individual optical fibers in each of the multi-fiber optical connectors can be associated with identifying each individual fiber and installing it in a predetermined path of the corresponding multi-fiber connector. The particular mapping of an optical fiber can be prescribed by accepted industry standards, such that users familiar with the given standard can employ an optical cable assembly or optical cable module of a given standard in the appropriate manner without significant characterization of each individual MIM.

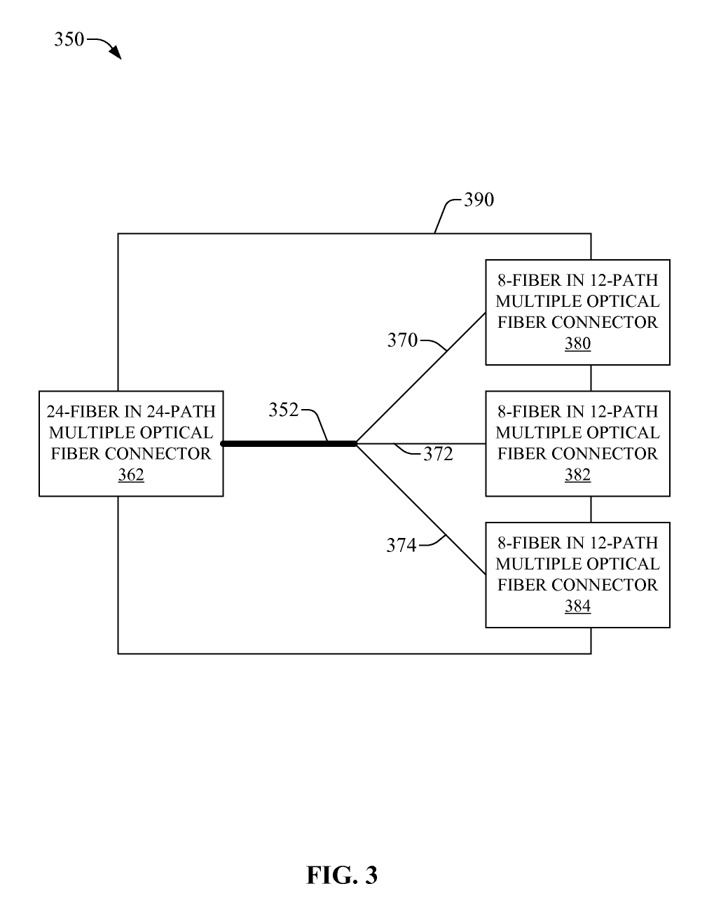

FIG. 3 illustrates a system 350, which facilitates optical coupling in accordance with aspects of the subject disclosure. System 350 can be similar to system 200 but includes a single multiple optical fiber connector 362 rather than a plurality, e.g., 220 and 222, terminating a first end of an optical cable 352. System 350 can illustrate a “1×24/24 to 3×8/12” MIM, e.g., the MIM includes one 24 fiber in 24 path optical connector 362 connected by a 24-fiber multi-fiber optical cable to three 8 fiber in 12 path optical connectors 380, 382 and 384. Installation of individual optical fibers in each of the multi-fiber optical connectors can be associated with identifying each individual fiber and installing it in a predetermined path of the corresponding multi-fiber connector. The particular mapping of an optical fiber can be prescribed by accepted industry standards, such that users familiar with the given standard can employ an optical cable assembly or optical cable module of a given standard in the appropriate manner without significant characterization of each MIM.

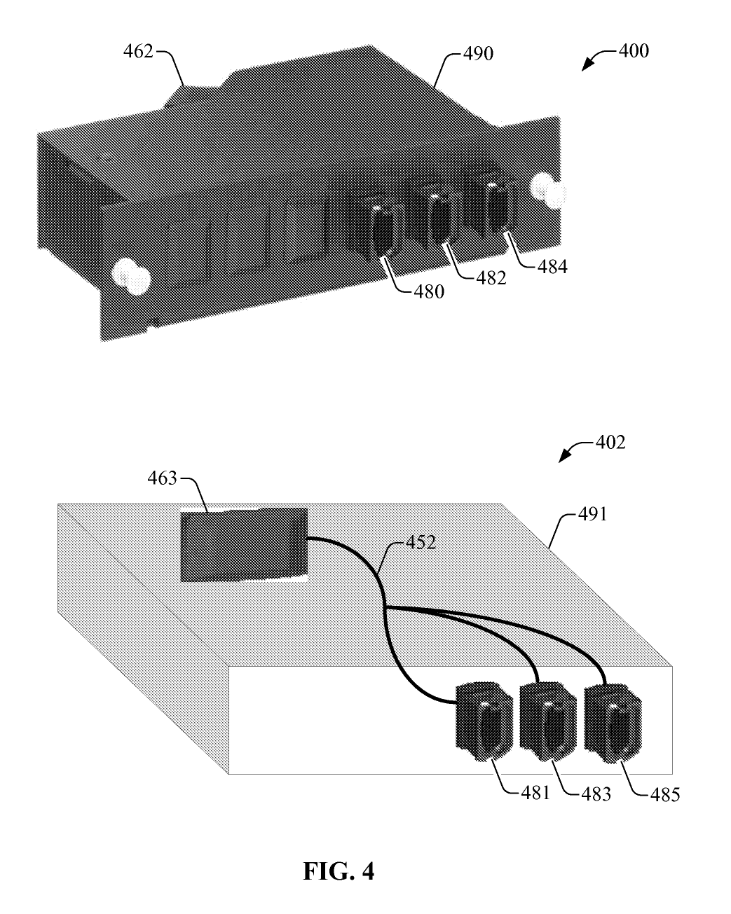

FIG. 4 illustrates exemplary systems 400 and 402, which can be MIMs. System 400 can be an illustration of a MIM that transitions between a single multi-fiber optical connector 462 and three multi-fiber optical connectors 480, 482, and 484. An exemplary system 400 can illustrate a “1×24/24 to 3×8/12” MIM, e.g., the MIM includes one 24 fiber in 24 path optical connector 462 connected by a 24-fiber multi-fiber optical cable, hidden inside enclosure 490, to three 8 fiber in 12 path optical connectors 480, 482 and 484. System 400 can include an enclosure 490. Enclosure 490 can be a walled enclosure. As an example, a MIM can be a MOCA mounted within a walled enclosure providing access to the connectors, to allow optical coupling of the fibers, while also limiting access to the remainder of the components within the walled enclosure.

System 402 can be another example of a MIM and can illustrate a cast-type MIM. A cast-type MIM can include casting an optical cable 452 and installed connectors 463, 481, 483, and 485, in a block of material 491, such as an epoxy, plastic, aerogel, urethane, etc. This type of MIM can provide access to the connectors in a manner similar to a walled enclosure but can do so without “walls.”

In an aspect, a cast-type module can be formed on a reusable fixture and can reduce the need for assembly of individual parts that can be associated with installing optical module components in a walled enclosure. The cast-type MIM can be formed in an appropriate manner around the optical fibers and connectors as compared to having to place the optical fibers and connectors mechanically into the walls and support structures of a walled-type enclosure. Cast-type modules can further include layered cast materials. It will be noted that any number of layers and materials can be employed in cast-type modules without departing from the instant disclosure. It will further be appreciated that the layers and materials can be of any appropriate geometry to provide the desired properties of the module.

In a further aspect, a cast-type MIM can encase other components. These other components can include mechanical components, such as reinforcing members, locks, latches, etc. These types of mechanical components can facilitate deployment of the MIM, for example, by casting a latch into the MIM, the MIM can be latched into a rack mount housing without the use of tools such as hex drivers or screwdrivers. Other components can also include sensors such as temperature probes, photosensors, etc. Further still, other components can include identifiers such as radio frequency identifiers (RFIDs) to allow identification of modules or tracking. Another example can include casting a bar code or Quick Response (“QR”) code into a portion of the casting that can be read optically, such as a clear portion of casting material or a casting that keeps the bar code or QR code at the surface of the MIM. Still further, a cast-type MIM can include cast voids either partially or wholly within the cast material. As an example, a void can be cast to form a carry handle through a MIM, to create a void so that the MIM weighs less, to create a void to facilitate greater cushioning effects from the casting materials, etc.

System 400 and system 402 can be of a standardized size and geometry accommodating deployment and maintenance of optical communications systems by providing drop in replaceable parts. In an aspect, system 400 and 402 can be interchangeable, e.g., a cast-type MIM can be equivalent to a walled MIM in function and geometry allowing the two types to be used interchangeably in deployed optical systems. In another aspect, a cast-type MIM can be smaller than a corresponding walled enclosure specifically because there are no wall structures in a cast-type MIM. The inherent support of casting the optical components directly in a material can provide support without the need for walls. As such, a cast-type MIM can be made smaller than a walled enclosure by at least the thickness of a corresponding walled enclosure's walls, illustrating internal support in contrast to external support.

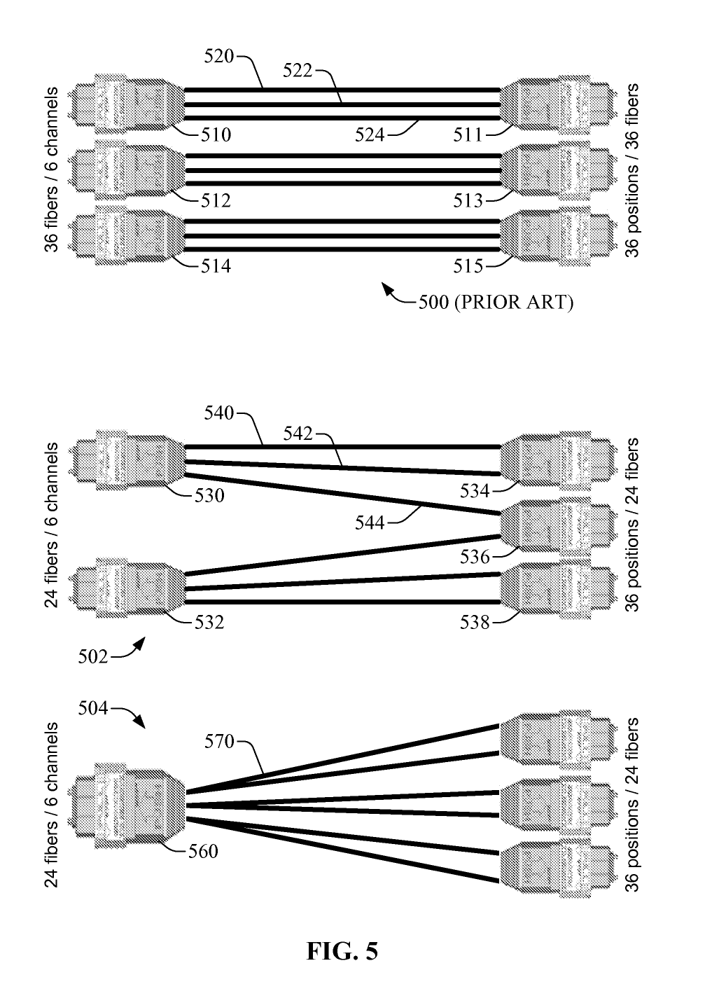

FIG. 5 illustrates exemplary fiber optic cable assemblies, e.g., MOCAs. Fiber optic cable assemblies 500 typify conventional fiber optic cable assemblies for optical coupling. Assemblies 500 include three cable assemblies having 36 fibers in 36 positions forming six optical channels wherein each optical channel comprises four individual optical fibers of the 36 available fibers. It is common for conventional fiber optic cable assemblies 500 to install fibers that are not actually employed in optical coupling, e.g., they just take up space in the cable assembly. The three exemplary fiber optic cable assemblies 500 include six 12-path multi-fiber optical fiber connectors 510-515. Each of these multi-fiber optical fiber connectors 510-515 has installed therein 12 individual optical fibers illustrated as three groups of four optical fibers, e.g., 520, 522, and 524 for multi-fiber optical fiber connectors 510 and 511.

In contrast, fiber optic cable assembly 502 illustrates the same six optical channels but with only five 12 path multi-fiber optical fiber connectors 530-538. This can be achieved by employing the unused optical fibers found in conventional fiber optic cable assemblies 500. As such, whereas the four optical fibers of 524 would typically go unused, assembly 502 uses them by routing them, as optical fibers 544, to connector 536. Similarly, fiber optic cable assembly 504 illustrates that the same six optical channels can be achieved employing only four multi-fiber optical fiber connectors. This can be achieved by employing a single 24-path multi-fiber optical fiber connector 560 in place of the two 12-path multi-fiber optical fiber connectors 530 and 532. As previously disclosed, where multi-fiber optical fiber connector size is similar between a 12-path and 24-path connector, using higher density multi-fiber optical fiber connectors can reduce the footprint of the MOCAs in an optical network environment, such as a rack enclosure. Further, as previously disclosed, employing higher density multi-fiber optical fiber connectors can provide a planned route for upgrading bandwidth in an optical system which can provide an extended period of use for components before having to replace them which can reduce deployment costs.

Of note, fiber optic cables can come in a myriad of constructions. Any fiber optic construction germane to installation with multi-fiber optical fiber connectors can be employed without departing from the scope of the subject disclosure. This can include both ribbon-type and round- or loose tube-type fiber optic cables including a plurality of optical fibers therein. Generally, ribbon cable can comprise individual optical fibers arranged in a planar array across an x-axis and extending in the z-axis. The optical fibers take on the appearance of a ribbon, hence the name ribbon cable. In an aspect, ribbon cable can offer excellent flexibility in a YZ-plane. In contrast, ribbon cable can demonstrate substantially less flexibility in the XZ-plane. This lack of flexibility in the XZ-plane can lead to insertion losses at optical connectors resulting from stresses on the ribbon cable. A loose tube round multi-fiber optical cable (round cable) can include one or more loose tubes, arrayed in a XY-plane and extending in a Z-axis direction, which in turn protect a plurality of individual optical fibers. Round cable geometry and design considerations can allow for an optical cable that is similarly flexible in both the YZ- and XZ-planes. In an aspect, the individual optical fibers are allowed to slide within each loose tube during a bending moment. This flexibility allows for a reduction in the stresses incurred to accommodate a bend as compared to being rigidly bound to the other structures of the round tube. Round tube is generally considered to be more flexible than ribbon cable. In an aspect, the optical fibers disclosed herein, e.g., 102, 152, 202, 352, etc. can be of any type, including either ribbon-type or round-type cable. Furthermore, whereas round cable is generally considered to be more flexible, the use of round cable as an optical fiber may be preferential in many situations to reduce insertion losses.

Of further note, fiber optic connector end faces can be polished in nearly any manner to facilitate optical interconnection with other components. Polish types can include flat, physical contact (PC), angled, etc. Flat polish is associated with polishing fibers flat orthogonal to the long axis of the optical fiber. Physical contact polish (PC polish) slightly radiuses the edges of a flat polish. Angle polish can be associated with polishing a flat angle across optical fibers, typically around 8 degrees. The optical cable assemblies and modules disclosed herein can employ any type of polish, including flat, PC, or angle polish types for the mating surfaces of the multi-fiber optical fiber connectors.

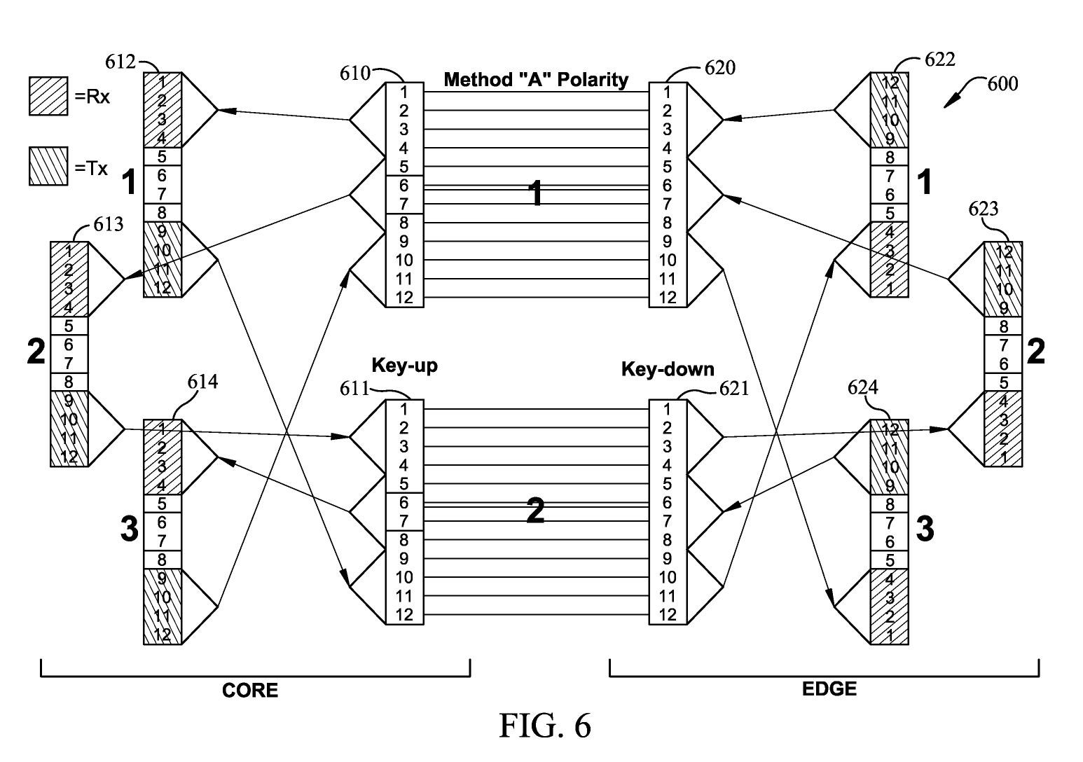

FIG. 6 illustrates an optical fiber grouping 600 that facilitates optical coupling in accordance with aspects of the subject disclosure. Optical fiber grouping 600 illustrates fiber positions within a plurality of multi-fiber connectors in general accordance with TIA/EIA-568 guidelines for Method A polarity. FIG. 6 can be roughly divided into a core side and an edge side that are optically coupled across a first 12-fiber optical cable between multi-fiber connector 610 and multi-fiber connector 620 and a second 12-fiber optical cable between multi-fiber connector 611 and multi-fiber connector 621. Optical signals can be generated by electronic, fiber optic and optoelectronic components coupled to “Tx” ports. Optical signals can be received by electronic, fiber optic and optoelectronic components coupled to “Rx” ports. Optical signals can be conducted from Tx ports to Rx ports, as mapped, between the core side components and the edge side components.

Multi-fiber connectors 610 to 614 and 620 to 624 can each be 12-path multi-fiber connectors. Multi-fiber connectors 610 and 611 can be fully populated, e.g., 12-fiber in 12-path multi-fiber connectors, as disclosed elsewhere herein. Multi-fiber connectors 612, 613 and 614 can be partially populated, e.g., 8-fiber in 12-path multi-fiber connectors, also as disclosed elsewhere herein. Similarly, multi-fiber connectors 620 and 621 can be fully populated, e.g., 12-fiber in 12-path multi-fiber connectors and multi-fiber connectors 622, 623 and 624 can be partially populated, e.g., 8-fiber in 12-path multi-fiber connectors.

As illustrated, on the core side, optical paths 1-4 of connector 610 can be optically coupled to optical paths 1-4 of connector 612, correspondingly. Optical paths 5-8 of connector 610 can be optically coupled to optical paths 1-4 of connector 613, correspondingly. Optical paths 9-12 of connector 610 can be optically coupled to optical paths 9-12 of connector 614, correspondingly. Optical paths 1-4 of connector 611 can be optically coupled to optical paths 9-12 of connector 613, correspondingly. Optical paths 5-8 of connector 611 can be optically coupled to optical paths 1-4 of connector 614, correspondingly. Optical paths 9-12 of connector 611 can be optically coupled to optical paths 9-12 of connector 612, correspondingly.

As further illustrated, on the edge side, optical paths 1-4 of connector 620 can be optically coupled to optical paths 12-9 of connector 622, correspondingly. Optical paths 5-8 of connector 620 can be optically coupled to optical paths 12-9 of connector 623, correspondingly. Optical paths 9-12 of connector 620 can be optically coupled to optical paths 4-1 of connector 624, correspondingly. Optical paths 1-4 of connector 621 can be optically coupled to optical paths 4-1 of connector 623, correspondingly. Optical paths 5-8 of connector 621 can be optically coupled to optical paths 12-9 of connector 624, correspondingly. Optical paths 9-12 of connector 621 can be optically coupled to optical paths 4-1 of connector 622, correspondingly.

Further, optical paths 1-12 of connector 610, in a key up configuration, can be coupled to optical paths 1-12 of connector 620, in a key down configuration, correspondingly. Similarly, optical paths 1-12 of connector 611, in a key up configuration, can be coupled to optical paths 1-12 of connector 621, in a key down configuration, correspondingly.

This particular configuration results in optical paths 1-4 and 9-12 of connector 612 being optically coupled to optical paths 12-9 and 4-1 of connector 622, correspondingly, and provides for a transmit and receive channel on both the core side and edge side for the connectors 612 and 622. Similarly, optical paths 1-4 and 9-12 of connector 613 can be optically coupled to optical paths 12-9 and 4-1 of connector 623, correspondingly, and a transmit and receive channel are again provided for each of the connectors 613 and 623. Further, optical paths 1-4 and 9-12 of connector 614 can be optically coupled to optical paths 12-9 and 4-1 of connector 624, correspondingly, and a transmit and receive channel are again provided for each of the connectors 614 and 624. Moreover, no perturbation of the optical fiber paths between connector pairs 610-620 and 611-621 occur. Furthermore, in accordance with Method A, connector pairs 610-620 and 611-621 are adapted to key up to key down connections, facilitating the insertion of additional cable assemblies key up to key down without loss of polarity between the core side and edge side optical paths.

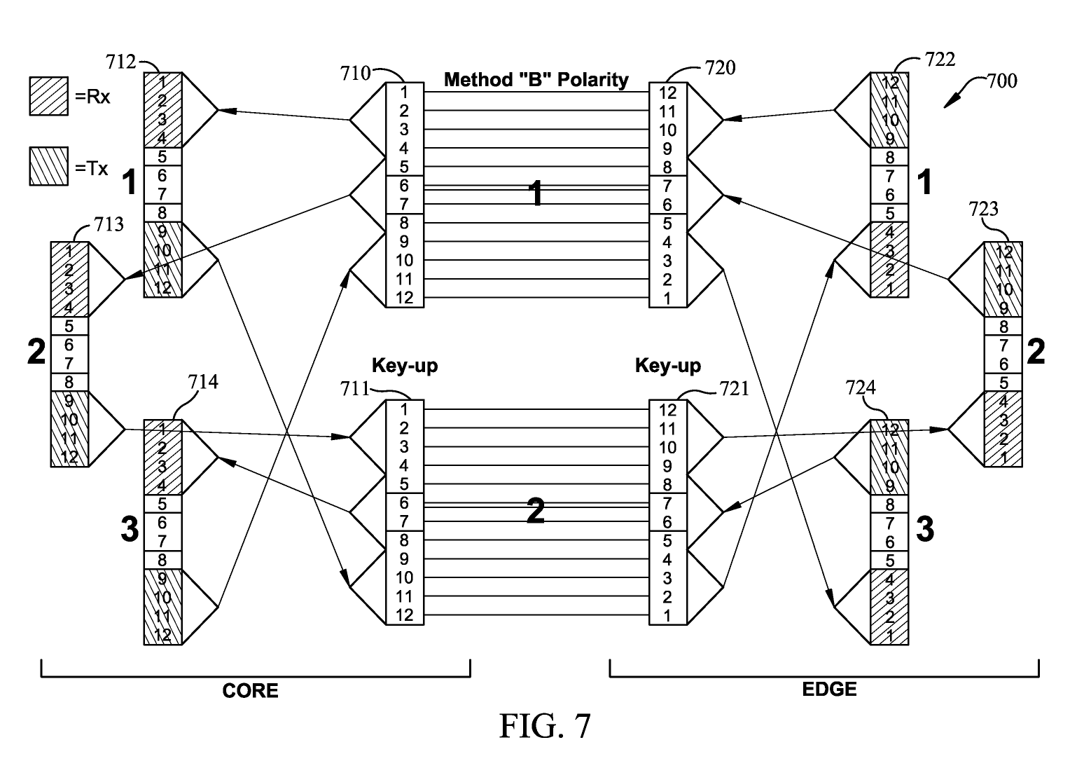

FIG. 7 illustrates an optical fiber grouping 700 that facilitates optical coupling in accordance with aspects of the subject disclosure. Optical fiber grouping 700 illustrates fiber positions within a plurality of multi-fiber connectors in general accordance with TIA/EIA-568 guidelines for Method B polarity. FIG. 7 can be roughly divided into a core side and an edge side that are optically coupled across a first 12-fiber optical cable between multi-fiber connector 710 and multi-fiber connector 720 and a second 12-fiber optical cable between multi-fiber connector 711 and multi-fiber connector 721. Optical signals can be generated by electronic, fiber optic and optoelectronic components coupled to “Tx” ports. Optical signals can be received by electronic, fiber optic and optoelectronic components coupled to “Rx” ports. Optical signals can be conducted from Tx ports to Rx ports, as mapped, between the core side components and the edge side components.

Multi-fiber connectors 710 to 714 and 720 to 724 can each be 12-path multi-fiber connectors. Multi-fiber connectors 710 and 711 can be fully populated, e.g., 12-fiber in 12-path multi-fiber connectors, as disclosed elsewhere herein. Multi-fiber connectors 712, 713 and 714 can be partially populated, e.g., 8-fiber in 12-path multi-fiber connectors, also as disclosed elsewhere herein. Similarly, multi-fiber connectors 720 and 721 can be fully populated, e.g., 12-fiber in 12-path multi-fiber connectors and multi-fiber connectors 722, 723 and 724 can be partially populated, e.g., 8-fiber in 12-path multi-fiber connectors.

As illustrated, on the core side, optical paths 1-4 of connector 710 can be optically coupled to optical paths 1-4 of connector 712, correspondingly. Optical paths 5-8 of connector 710 can be optically coupled to optical paths 1-4 of connector 713, correspondingly. Optical paths 9-12 of connector 710 can be optically coupled to optical paths 9-12 of connector 714, correspondingly. Optical paths 1-4 of connector 711 can be optically coupled to optical paths 9-12 of connector 713, correspondingly. Optical paths 5-8 of connector 711 can be optically coupled to optical paths 1-4 of connector 714, correspondingly. Optical paths 9-12 of connector 711 can be optically coupled to optical paths 9-12 of connector 712, correspondingly.

As further illustrated, on the edge side, optical paths 12-9 of connector 720 can be optically coupled to optical paths 12-9 of connector 722, correspondingly. Optical paths 8-5 of connector 720 can be optically coupled to optical paths 12-9 of connector 723, correspondingly. Optical paths 4-1 of connector 720 can be optically coupled to optical paths 4-1 of connector 724, correspondingly. Optical paths 12-9 of connector 721 can be optically coupled to optical paths 4-1 of connector 723, correspondingly. Optical paths 8-5 of connector 721 can be optically coupled to optical paths 12-9 of connector 724, correspondingly. Optical paths 4-1 of connector 721 can be optically coupled to optical paths 4-1 of connector 722, correspondingly.

Further, optical paths 1-12 of connector 710, in a key up configuration, can be coupled to optical paths 1-12 of connector 720, in a key up configuration, correspondingly. Similarly, optical paths 1-12 of connector 711, in a key up configuration, can be coupled to optical paths 1-12 of connector 721, in a key up configuration, correspondingly.

This particular configuration results in optical paths 1-4 and 9-12 of connector 712 being optically coupled to optical paths 12-9 and 4-1 of connector 722, correspondingly, and provides for a transmit and receive channel on both the core side and edge side for the connectors 712 and 722. Similarly, optical paths 1-4 and 9-12 of connector 713 can be optically coupled to optical paths 12-9 and 4-1 of connector 723, correspondingly, and a transmit and receive channel are again provided for each of the connectors 713 and 723. Further, optical paths 1-4 and 9-12 of connector 714 can be optically coupled to optical paths 12-9 and 4-1 of connector 724, correspondingly, and a transmit and receive channel are again provided for each of the connectors 714 and 724. Moreover, no perturbation of the optical fiber paths between connector pairs 710-720 and 711-721 occur. Furthermore, in accordance with Method B, connectors pairs 710-720 and 711-721 are adapted to key up to key up connections, facilitating the insertion of additional cable assemblies key up to key up without loss of polarity between the core side and edge side optical paths.

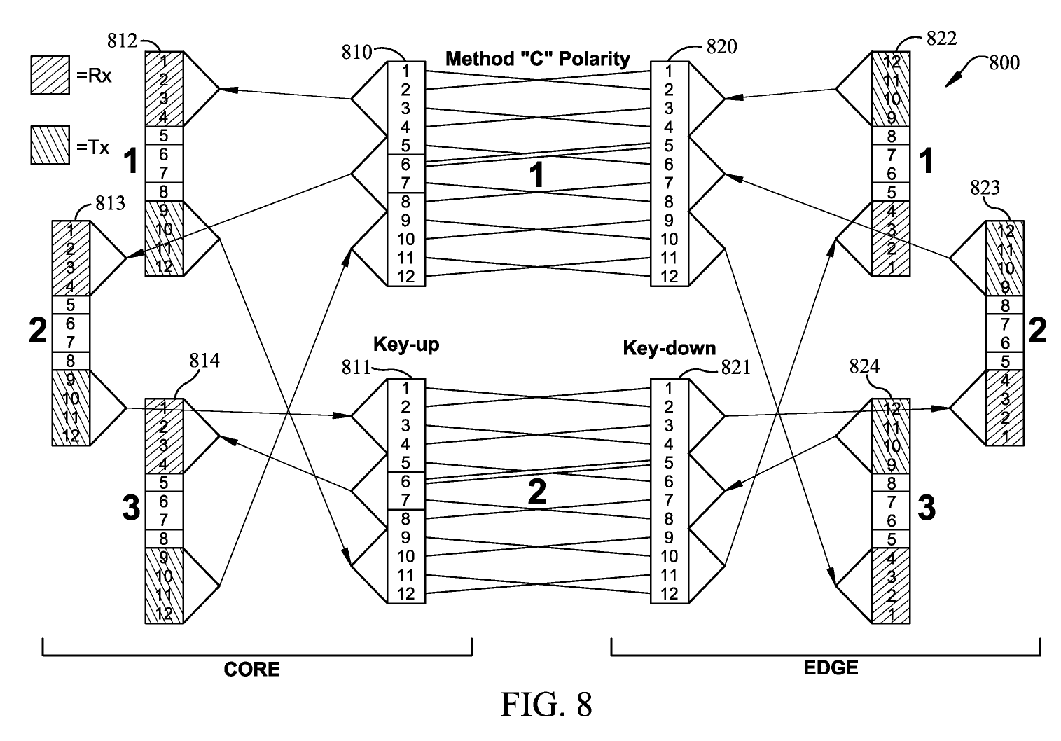

FIG. 8 illustrates an optical fiber grouping 800 that facilitates optical coupling in accordance with aspects of the subject disclosure. Optical fiber grouping 800 illustrates fiber positions within a plurality of multi-fiber connectors in general accordance with TIA/EIA-568 guidelines for Method C polarity. FIG. 8 can be roughly divided into a core side and an edge side that are optically coupled across a first 12-fiber optical cable between multi-fiber connector 810 and multi-fiber connector 820 and a second 12-fiber optical cable between multi-fiber connector 811 and multi-fiber connector 821. Optical signals can be generated by electronic, fiber optic and optoelectronic components coupled to “Tx” ports. Optical signals can be received by electronic, fiber optic and optoelectronic components coupled to “Rx” ports. Optical signals can be conducted from Tx ports to Rx ports, as mapped, between the core side components and the edge side components.

Multi-fiber connectors 810 to 814 and 820 to 824 can each be 12-path multi-fiber connectors. Multi-fiber connectors 810 and 811 can be fully populated, e.g., 12-fiber in 12-path multi-fiber connectors, as disclosed elsewhere herein. Multi-fiber connectors 812, 813 and 814 can be partially populated, e.g., 8-fiber in 12-path multi-fiber connectors, also as disclosed elsewhere herein. Similarly, multi-fiber connectors 820 and 821 can be fully populated, e.g., 12-fiber in 12-path multi-fiber connectors and multi-fiber connectors 822, 823 and 824 can be partially populated, e.g., 8-fiber in 12-path multi-fiber connectors.

As illustrated, on the core side, optical paths 1-4 of connector 810 can be optically coupled to optical paths 1-4 of connector 812, correspondingly. Optical paths 5-8 of connector 810 can be optically coupled to optical paths 1-4 of connector 813, correspondingly. Optical paths 9-12 of connector 810 can be optically coupled to optical paths 9-12 of connector 814, correspondingly. Optical paths 1-4 of connector 811 can be optically coupled to optical paths 9-12 of connector 813, correspondingly. Optical paths 5-8 of connector 811 can be optically coupled to optical paths 1-4 of connector 814, correspondingly. Optical paths 9-12 of connector 811 can be optically coupled to optical paths 9-12 of connector 812, correspondingly.

As further illustrated, on the edge side, optical paths 1-4 of connector 820 can be optically coupled to optical paths 12-9 of connector 822, correspondingly. Optical paths 5-8 of connector 820 can be optically coupled to optical paths 12-9 of connector 823, correspondingly. Optical paths 9-12 of connector 820 can be optically coupled to optical paths 4-1 of connector 824, correspondingly. Optical paths 1-4 of connector 821 can be optically coupled to optical paths 4-1 of connector 823, correspondingly. Optical paths 5-8 of connector 821 can be optically coupled to optical paths 12-9 of connector 824, correspondingly. Optical paths 9-12 of connector 821 can be optically coupled to optical paths 4-1 of connector 822, correspondingly.

Further, the optical paths of connector 810, in a key up configuration, can be coupled to the optical paths of connector 820, in a key down configuration, in a pair-wise flip configuration. This results in the following pairs, listed as “810 path-820 path,” {1-2, 2-1, 3-4, 4-3, 5-6, 6-5, 7-8, 8-7, 9-10, 10-9, 11-12, 12-11}. Similarly, the optical paths of connector 811, in a key up configuration, can be coupled to the optical paths of connector 821, in a key down configuration, in a pair-wise flip configuration. This results in the following pairs, listed as “811 path-821 path,” {1-2, 2-1, 3-4, 4-3, 5-6, 6-5, 7-8, 8-7, 9-10, 10-9, 11-12, 12-11}.

This particular configuration results in optical paths 1-4 and 9-12 of connector 812 being optically coupled to optical paths 12-9 and 4-1 of connector 822, with a pair-wise flip {1-11, 2-12, 3-9, 4-10 and 9-3, 10-4, 11-1, 12-2}, and provides for a transmit and receive channel on both the core side and edge side for the connectors 812 and 822. Similarly, optical paths 1-4 and 9-12 of connector 813 can be optically coupled to optical paths 12-9 and 4-1 of connector 823, with a pair-wise flip {1-11, 2-12, 3-9, 4-10 and 9-3, 10-4, 11-1, 12-2}, and a transmit and receive channel are again provided for each of the connectors 813 and 823. Further, optical paths 1-4 and 9-12 of connector 814 can be optically coupled to optical paths 12-9 and 4-1 of connector 824, with a pair-wise flip {1-11, 2-12, 3-9, 4-10 and 9-3, 10-4, 11-1, 12-2}, and a transmit and receive channel are again provided for each of the connectors 814 and 824. As illustrated, a pair-wise flip perturbation of the optical fiber paths between connectors pairs 810-820 and 811-821 occurs. Furthermore, in accordance with Method C, connectors pairs 810-820 and 811-821 are adapted to key up to key down connections, facilitating the insertion of additional cable assemblies in pairs of key up to key down cables to preserve polarity between the core side and edge side optical paths.

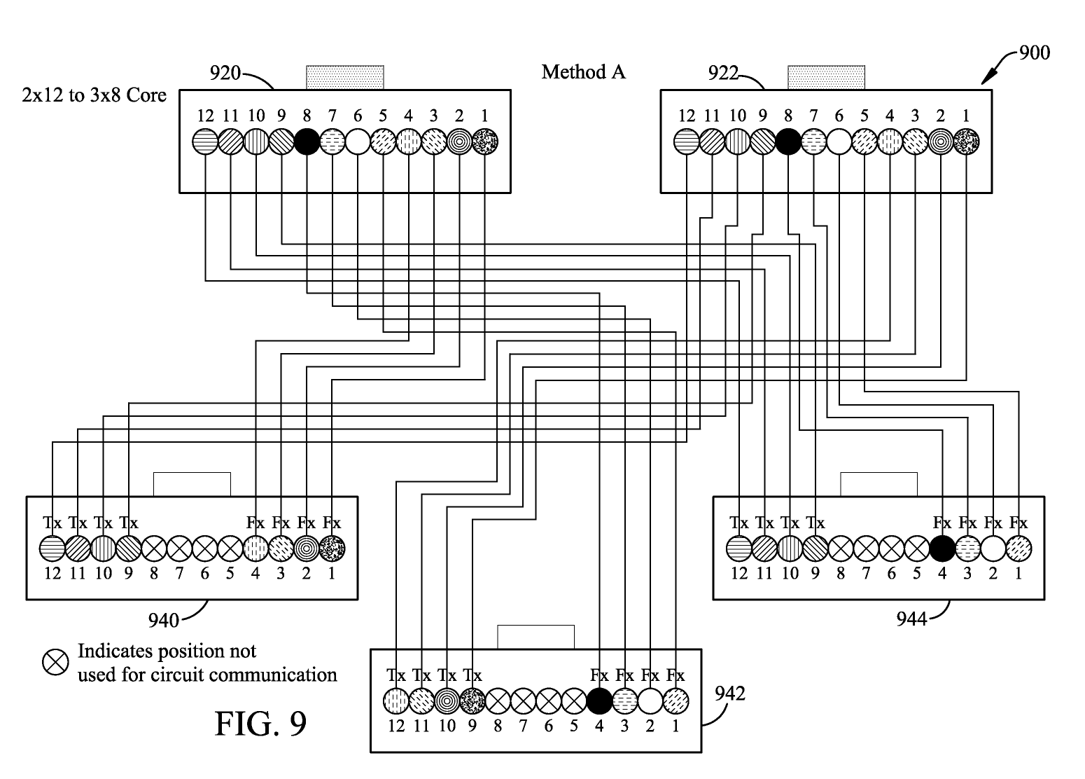

FIG. 9 illustrates a core side optical fiber layout schematic 900 that facilitates optical coupling in accordance with aspects of the subject disclosure. Schematic 900 presents optical fiber routing between a plurality of multi-fiber connectors in general accordance with TIA/EIA-568 guidelines for Method A polarity. FIG. 9 can represent an optical fiber layout for a core side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connectors 920 to 922 can each be fully populated, e.g., 12-fiber in 12-path multi-fiber connectors, in a key up configuration as disclosed elsewhere herein. Multi-fiber connectors 940, 942 and 944 can be partially populated, e.g., 8-fiber in 12-path multi-fiber connectors, in a key up configuration, also as disclosed elsewhere herein. Optical routing layout coupling can be summarized in Table 4.

| Connector | | | |
|---|---|---|---|
| Position of | Connector 940 | Connector 942 | Connector 944 |
| 940, 942, | coupled to | coupled to | coupled to |
| or 944 | position: | position: | position: |
| 1 | 1 of 920 | 5 of 920 | 5 of 922 |
| 2 | 2 of 920 | 6 of 920 | 6 of 922 |
| 3 | 3 of 920 | 7 of 920 | 7 of 922 |
| 4 | 4 of 920 | 8 of 920 | 8 of 922 |
| 5 | empty | empty | Empty |
| 6 | empty | empty | Empty |
| 7 | empty | empty | Empty |
| 8 | empty | empty | Empty |
| 9 | 9 of 922 | 1 of 922 | 9 of 920 |
| 10 | 10 of 922 | 2 of 922 | 10 of 920 |
| 11 | 11 of 922 | 3 of 922 | 11 of 920 |
| 12 | 12 of 922 | 4 of 922 | 12 of 920 |

Table 4 summarizes optical fiber layout for a core side 2×12/12 to 3×8/12 multi-fiber optical assembly of Method A polarity.

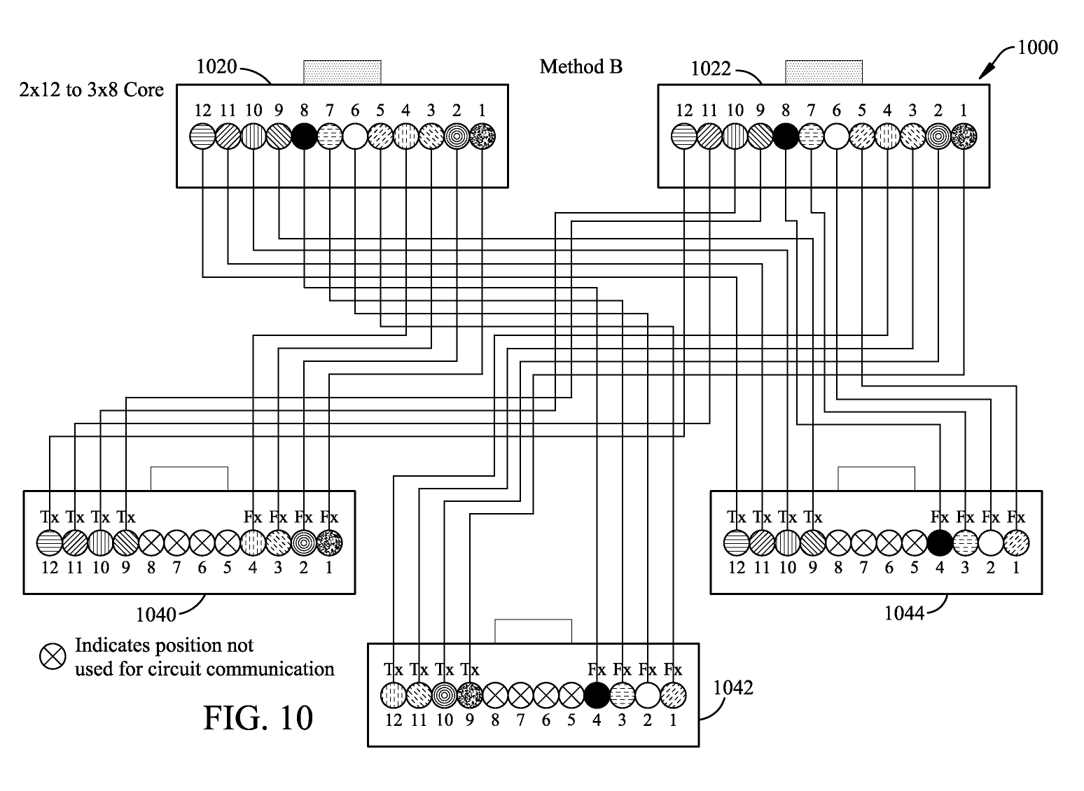

FIG. 10 illustrates a core side optical fiber layout schematic 1000 that facilitates optical coupling in accordance with aspects of the subject disclosure. Schematic 1000 presents optical fiber routing between a plurality of multi-fiber connectors in general accordance with TIA/EIA-568 guidelines for Method B polarity. FIG. 10 can represent an optical fiber layout for a core side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connectors 1020 to 1022 can each be fully populated, e.g., 12-fiber in 12-path multi-fiber connectors, in a key up configuration as disclosed elsewhere herein. Multi-fiber connectors 1040, 1042 and 1044 can be partially populated, e.g., 8-fiber in 12-path multi-fiber connectors, in a key up configuration, also as disclosed elsewhere herein. Optical routing layout coupling can be summarized in Table 5.

| Connector | | | |
|---|---|---|---|
| Position of | Connector 1040 | Connector 1042 | Connector 1044 |
| 1040, 1042, | coupled to | coupled to | coupled to |
| or 1044 | position: | position: | position: |
| 1 | 1 of 1020 | 5 of 1020 | 5 of 1022 |
| 2 | 2 of 1020 | 6 of 1020 | 6 of 1022 |
| 3 | 3 of 1020 | 7 of 1020 | 7 of 1022 |
| 4 | 4 of 1020 | 8 of 1020 | 8 of 1022 |
| 5 | empty | Empty | Empty |
| 6 | empty | Empty | Empty |
| 7 | empty | Empty | Empty |
| 8 | empty | Empty | Empty |
| 9 | 9 of 1022 | 1 of 1022 | 9 of 1020 |
| 10 | 10 of 1022 | 2 of 1022 | 10 of 1020 |
| 11 | 11 of 1022 | 3 of 1022 | 11 of 1020 |
| 12 | 12 of 1022 | 4 of 1022 | 12 of 1020 |

Table 5 summarizes optical fiber layout for a core side 2×12/12 to 3×8/12 multi-fiber optical assembly of Method B polarity.

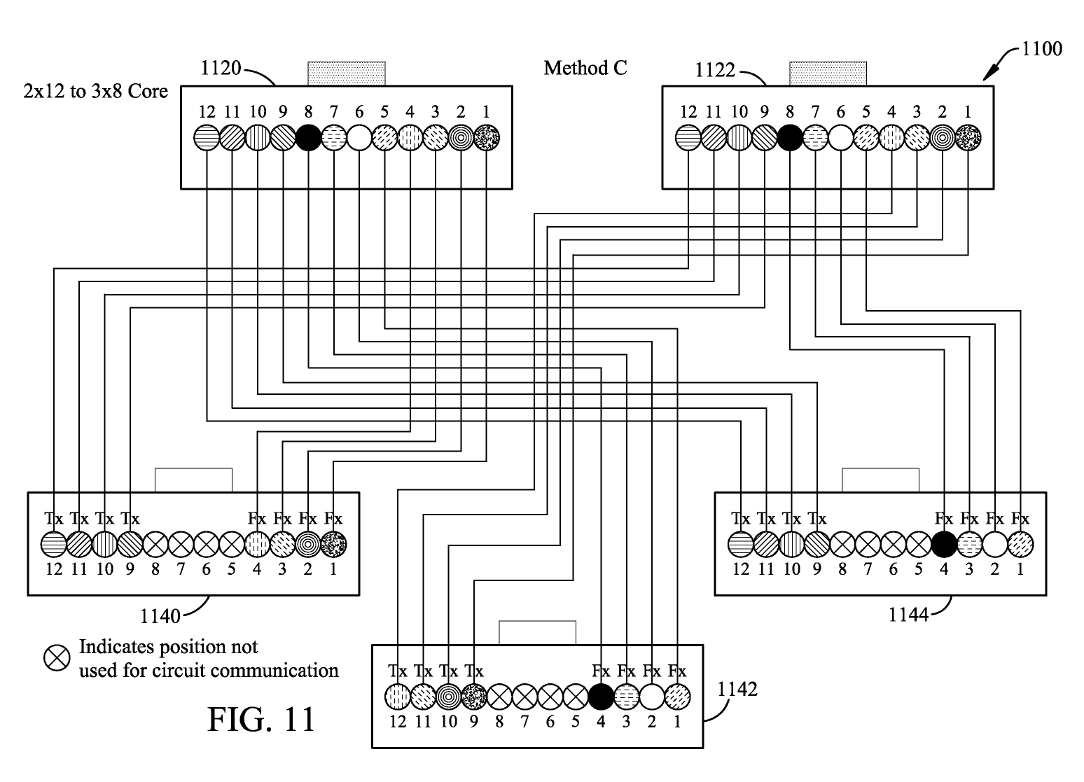

FIG. 11 illustrates a core side optical fiber layout schematic 1100 that facilitates optical coupling in accordance with aspects of the subject disclosure. Schematic 1100 presents optical fiber routing between a plurality of multi-fiber connectors in general accordance with TIA/EIA-568 guidelines for Method C polarity. FIG. 11 can represent an optical fiber layout for a core side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connectors 1120 to 1122 can each be fully populated, e.g., 12-fiber in 12-path multi-fiber connectors, in a key up configuration as disclosed elsewhere herein. Multi-fiber connectors 1140, 1142 and 1144 can be partially populated, e.g., 8-fiber in 12-path multi-fiber connectors, in a key up configuration, also as disclosed elsewhere herein. Optical routing layout coupling can be summarized in Table 6.

| Connector | | | |
|---|---|---|---|
| Position of | Connector 1140 | Connector 1142 | Connector 1144 |
| 1140, 1142, | coupled to | coupled to | coupled to |
| or 1144 | position: | position: | position: |
| 1 | 1 of 1120 | 5 of 1120 | 5 of 1122 |
| 2 | 2 of 1120 | 6 of 1120 | 6 of 1122 |
| 3 | 3 of 1120 | 7 of 1120 | 7 of 1122 |
| 4 | 4 of 1120 | 8 of 1120 | 8 of 1122 |
| 5 | empty | empty | Empty |
| 6 | empty | empty | Empty |
| 7 | empty | empty | Empty |
| 8 | empty | empty | Empty |
| 9 | 9 of 1122 | 1 of 1122 | 9 of 1120 |
| 10 | 10 of 1122 | 2 of 1122 | 10 of 1120 |
| 11 | 11 of 1122 | 3 of 1122 | 11 of 1120 |
| 12 | 12 of 1122 | 4 of 1122 | 12 of 1120 |

Table 6 summarizes optical fiber layout for a core side 2×12/12 to 3×8/12 multi-fiber optical assembly of Method C polarity.

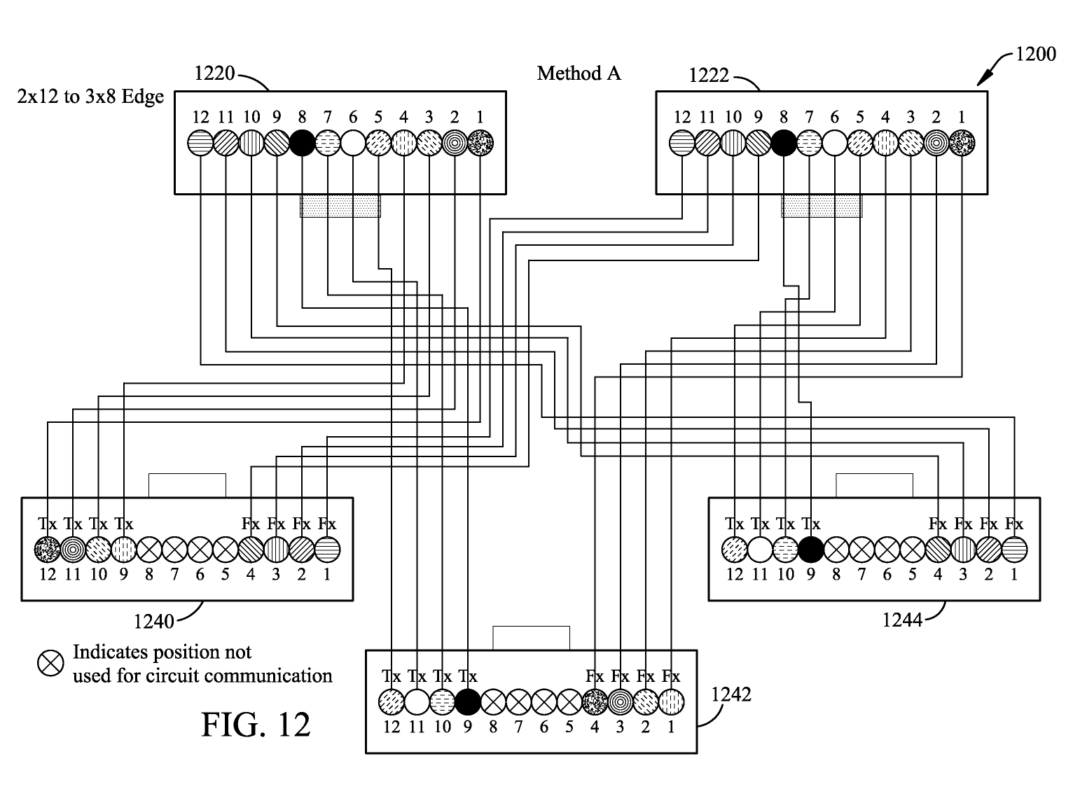

FIG. 12 illustrates an edge side optical fiber layout schematic 1200 that facilitates optical coupling in accordance with aspects of the subject disclosure. Schematic 1200 presents optical fiber routing between a plurality of multi-fiber connectors in general accordance with TIA/EIA-568 guidelines for Method A polarity. FIG. 12 can represent an optical fiber layout for an edge side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connectors 1220 to 1222 can each be fully populated, e.g., 12-fiber in 12-path multi-fiber connectors, in a key down configuration as disclosed elsewhere herein. Multi-fiber connectors 1240, 1242 and 1244 can be partially populated, e.g., 8-fiber in 12-path multi-fiber connectors, in a key up configuration, also as disclosed elsewhere herein. Optical routing layout coupling can be summarized in Table 7.

| Connector | | | |
|---|---|---|---|
| Position of | Connector 1240 | Connector 1242 | Connector 1244 |
| 1240, 1242, | coupled to | coupled to | coupled to |
| or 1244 | position: | position: | position: |
| 1 | 12 of 1222 | 4 of 1222 | 12 of 1220 |
| 2 | 11 of 1222 | 3 of 1222 | 11 of 1220 |
| 3 | 10 of 1222 | 2 of 1222 | 10 of 1220 |
| 4 | 9 of 1222 | 1 of 1222 | 9 of 1220 |
| 5 | empty | empty | Empty |
| 6 | empty | empty | Empty |
| 7 | empty | empty | Empty |
| 8 | empty | empty | Empty |
| 9 | 4 of 1220 | 8 of 1220 | 8 of 1222 |
| 10 | 3 of 1220 | 7 of 1220 | 7 of 1222 |
| 11 | 2 of 1220 | 6 of 1220 | 6 of 1222 |
| 12 | 1 of 1220 | 5 of 1220 | 5 of 1222 |

Table 7 summarizes optical fiber layout for an edge side 2×12/12 to 3×8/12 multi-fiber optical assembly of Method A polarity.

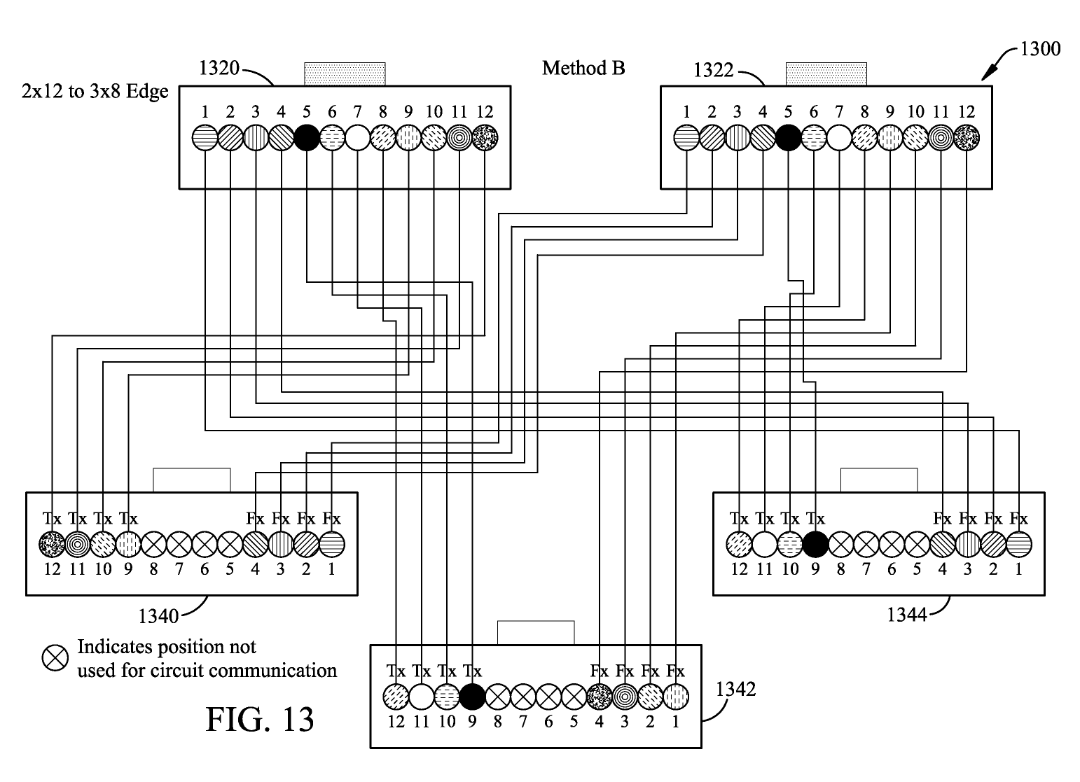

FIG. 13 illustrates an edge side optical fiber layout schematic 1300 that facilitates optical coupling in accordance with aspects of the subject disclosure. Schematic 1300 presents optical fiber routing between a plurality of multi-fiber connectors in general accordance with TIA/EIA-568 guidelines for Method B polarity. FIG. 13 can represent an optical fiber layout for an edge side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connectors 1320 to 1322 can each be fully populated, e.g., 12-fiber in 12-path multi-fiber connectors, in a key up configuration as disclosed elsewhere herein. Multi-fiber connectors 1340, 1342 and 1344 can be partially populated, e.g., 8-fiber in 12-path multi-fiber connectors, in a key up configuration, also as disclosed elsewhere herein. Optical routing layout coupling can be summarized in Table 8.

| Connector | | | |
|---|---|---|---|
| Position of | Connector 1340 | Connector 1342 | Connector 1344 |
| 1340, 1342, | coupled to | coupled to | coupled to |
| or 1344 | position: | position: | position: |
| 1 | 1 of 1322 | 9 of 1322 | 1 of 1320 |
| 2 | 2 of 1322 | 10 of 1322 | 2 of 1320 |
| 3 | 3 of 1322 | 11 of 1322 | 3 of 1320 |
| 4 | 4 of 1322 | 12 of 1322 | 4 of 1320 |
| 5 | empty | empty | Empty |
| 6 | empty | empty | Empty |
| 7 | empty | empty | Empty |
| 8 | empty | empty | Empty |
| 9 | 9 of 1320 | 5 of 1320 | 5 of 1322 |
| 10 | 10 of 1320 | 6 of 1320 | 6 of 1322 |
| 11 | 11 of 1320 | 7 of 1320 | 7 of 1322 |
| 12 | 12 of 1320 | 8 of 1320 | 8 of 1322 |

Table 8 summarizes optical fiber layout for an edge side 2×12/12 to 3×8/12 multi-fiber optical assembly of Method B polarity.

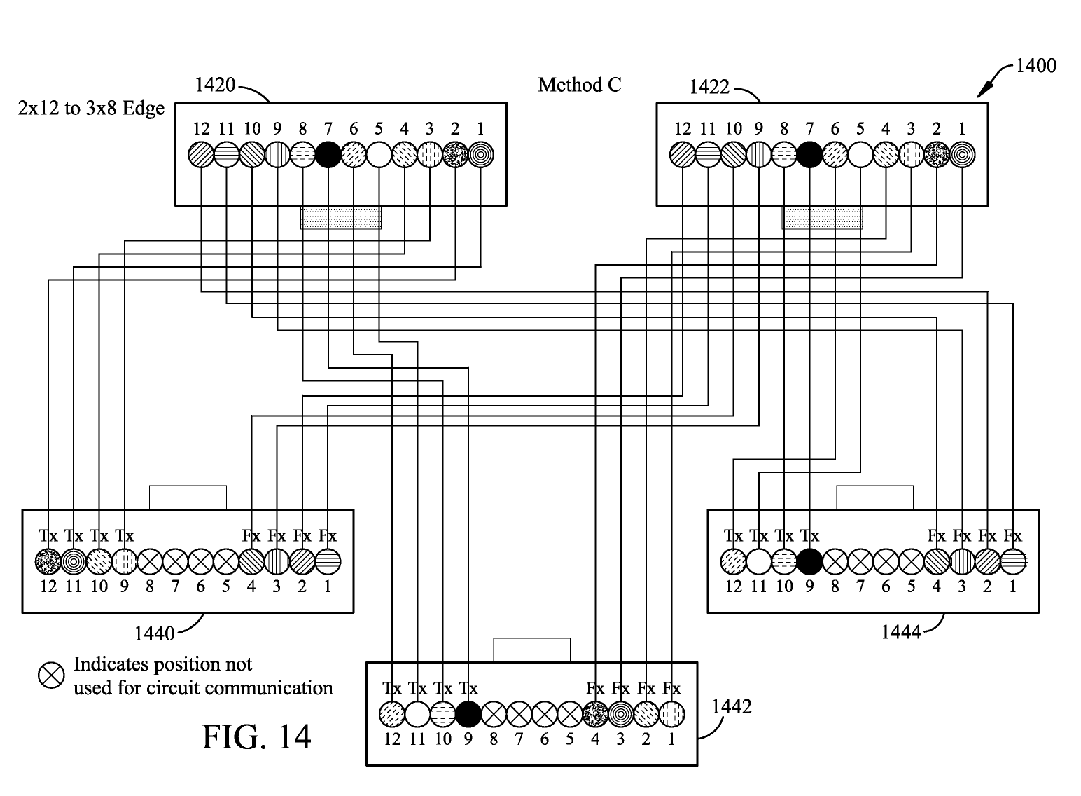

FIG. 14 illustrates an edge side optical fiber layout schematic 1400 that facilitates optical coupling in accordance with aspects of the subject disclosure. Schematic 1400 presents optical fiber routing between a plurality of multi-fiber connectors in general accordance with TIA/EIA-568 guidelines for Method C polarity. FIG. 14 can represent an optical fiber layout for an edge side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connectors 1420 to 1422 can each be fully populated, e.g., 12-fiber in 12-path multi-fiber connectors, in a key down configuration as disclosed elsewhere herein. Multi-fiber connectors 1440, 1442 and 1444 can be partially populated, e.g., 8-fiber in 12-path multi-fiber connectors, in a key up configuration, also as disclosed elsewhere herein. Optical routing layout coupling can be summarized in Table 9.

| Connector | | | |
|---|---|---|---|
| Position of | Connector 1440 | Connector 1442 | Connector 1444 |
| 1440, 1442, | coupled to | coupled to | coupled to |
| or 1444 | position: | position: | position: |
| 1 | 11 of 1422 | 3 of 1422 | 11 of 1420 |
| 2 | 12 of 1422 | 4 of 1422 | 12 of 1420 |
| 3 | 9 of 1422 | 1 of 1422 | 9 of 1420 |
| 4 | 10 of 1422 | 2 of 1422 | 10 of 1420 |
| 5 | empty | empty | Empty |
| 6 | empty | empty | Empty |
| 7 | empty | empty | Empty |
| 8 | empty | empty | Empty |
| 9 | 3 of 1420 | 7 of 1420 | 7 of 1422 |
| 10 | 4 of 1420 | 8 of 1420 | 8 of 1422 |
| 11 | 1 of 1420 | 5 of 1420 | 5 of 1422 |
| 12 | 2 of 1420 | 6 of 1420 | 6 of 1422 |

Table 9 summarizes optical fiber layout for an edge side 2×12/12 to 3×8/12 multi-fiber optical assembly of Method C polarity.

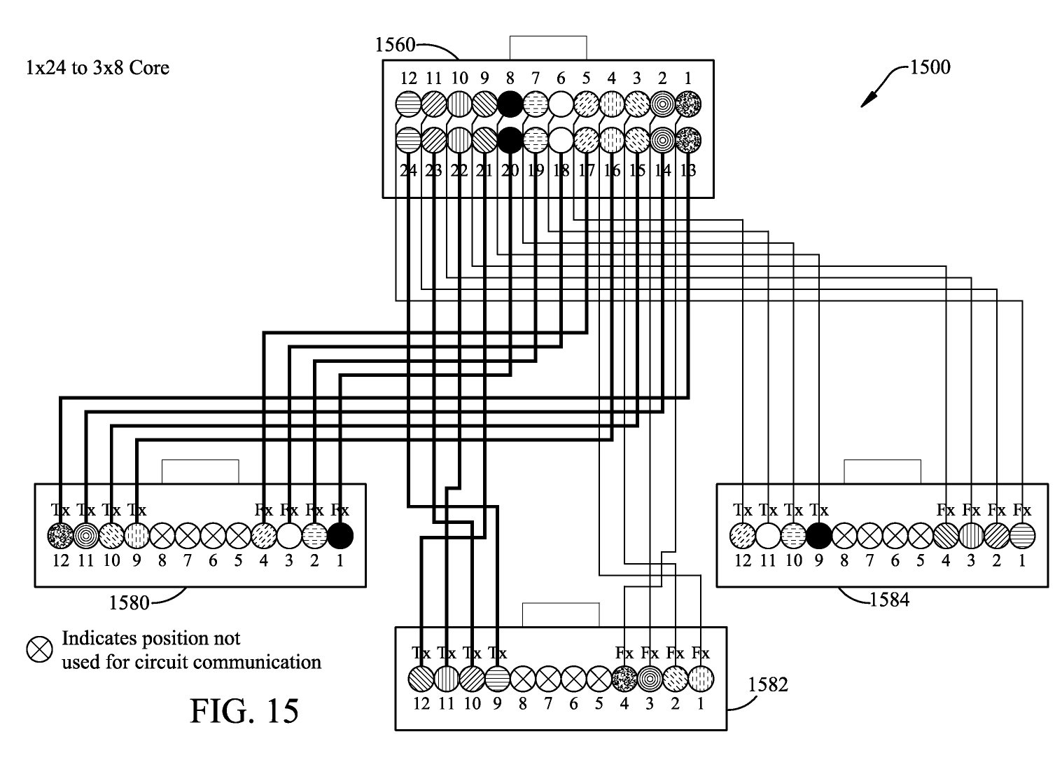

FIG. 15 illustrates a core side optical fiber layout schematic 1500 that facilitates optical coupling in accordance with aspects of the subject disclosure. Schematic 1500 presents optical fiber routing between a plurality of multi-fiber connectors. FIG. 15 can represent an optical fiber layout for a core side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connector 1560 can be fully populated, e.g., a 24-fiber in 24-path multi-fiber connector, in a key up configuration as disclosed elsewhere herein. Multi-fiber connectors 1580, 1582 and 1584 can be partially populated, e.g., 8-fiber in 12-path multi-fiber connectors, in a key up configuration, also as disclosed elsewhere herein. Optical routing layout coupling can be summarized in Table 10.

| Connector | | | |
|---|---|---|---|
| Position of | Connector 1580 | Connector 1582 | Connector 1584 |
| 1580, 1582, | coupled to | coupled to | coupled to |
| or 1584 | position: | position: | position: |
| 1 | 20 | 4 | 12 |
| 2 | 19 | 3 | 11 |
| 3 | 18 | 2 | 10 |
| 4 | 17 | 1 | 9 |
| 5 | empty | empty | empty |
| 6 | empty | empty | empty |
| 7 | empty | empty | empty |
| 8 | empty | empty | empty |
| 9 | 16 | 24 | 8 |
| 10 | 15 | 23 | 7 |
| 11 | 14 | 22 | 6 |
| 12 | 13 | 21 | 5 |

Table 10 summarizes optical fiber layout for a core side 1×24/24 to 3×8/12 multi-fiber optical assembly.

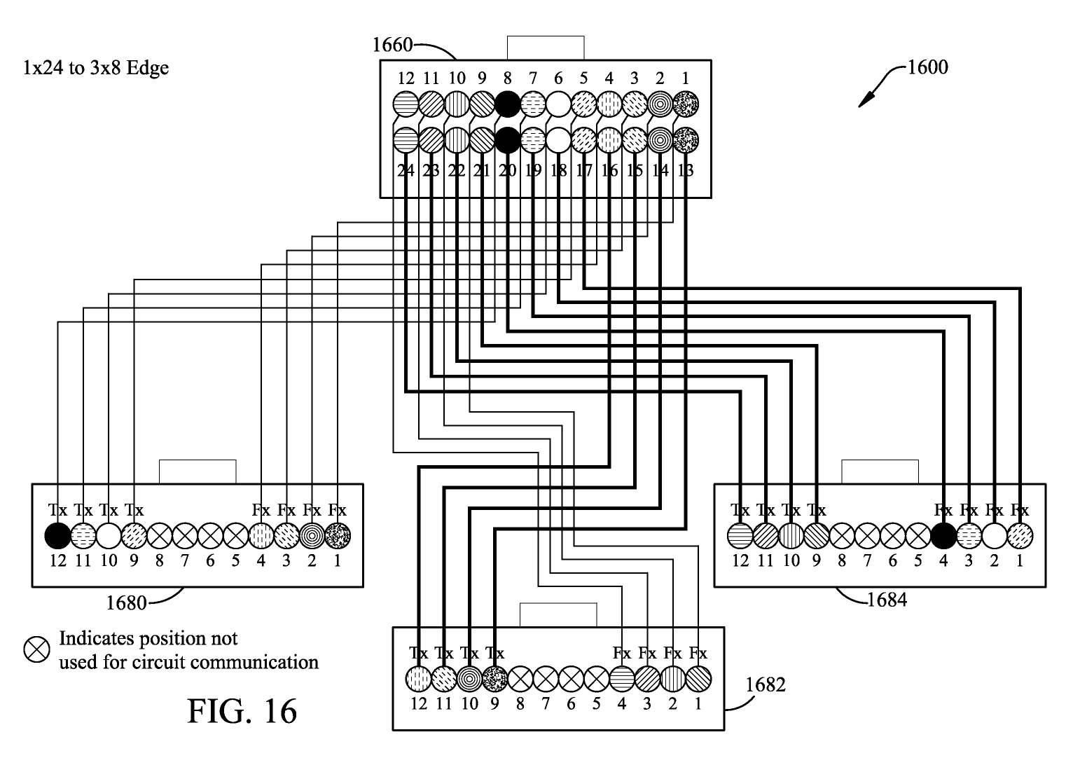

FIG. 16 illustrates an edge side optical fiber layout schematic 1600 that facilitates optical coupling in accordance with aspects of the subject disclosure. Schematic 1600 presents optical fiber routing between a plurality of multi-fiber connectors. FIG. 16 can represent an optical fiber layout for an edge side optical cable assembly or module. Optical signals can be generated by electronic, fiber optic and optoelectronic components coupled to “Tx” ports. Optical signals can be received by electronic, fiber optic and optoelectronic components coupled to “Rx” ports. Multi-fiber connector 1660 can be fully populated, e.g., a 24-fiber in 24-path multi-fiber connector, in a key up configuration as disclosed elsewhere herein. Multi-fiber connectors 1680, 1682 and 1684 can be partially populated, e.g., 8-fiber in 12-path multi-fiber connectors, in a key up configuration, also as disclosed elsewhere herein. Optical routing layout coupling can be summarized in Table 11.

| Connector | | | |
|---|---|---|---|
| Position of | Connector 1680 | Connector 1682 | Connector 1684 |
| 1680, 1682, | coupled to | coupled to | coupled to |
| or 1684 | position: | position: | position: |
| 1 | 1 | 9 | 17 |
| 2 | 2 | 10 | 18 |
| 3 | 3 | 11 | 19 |
| 4 | 4 | 12 | 20 |
| 5 | empty | empty | empty |
| 6 | empty | empty | empty |
| 7 | empty | empty | empty |
| 8 | empty | empty | empty |
| 9 | 5 | 13 | 21 |
| 10 | 6 | 14 | 22 |
| 11 | 7 | 15 | 23 |
| 12 | 8 | 16 | 24 |

Table 11 summarizes optical fiber layout for an edge side 1×24/24 to 3×8/12 multi-fiber optical assembly.

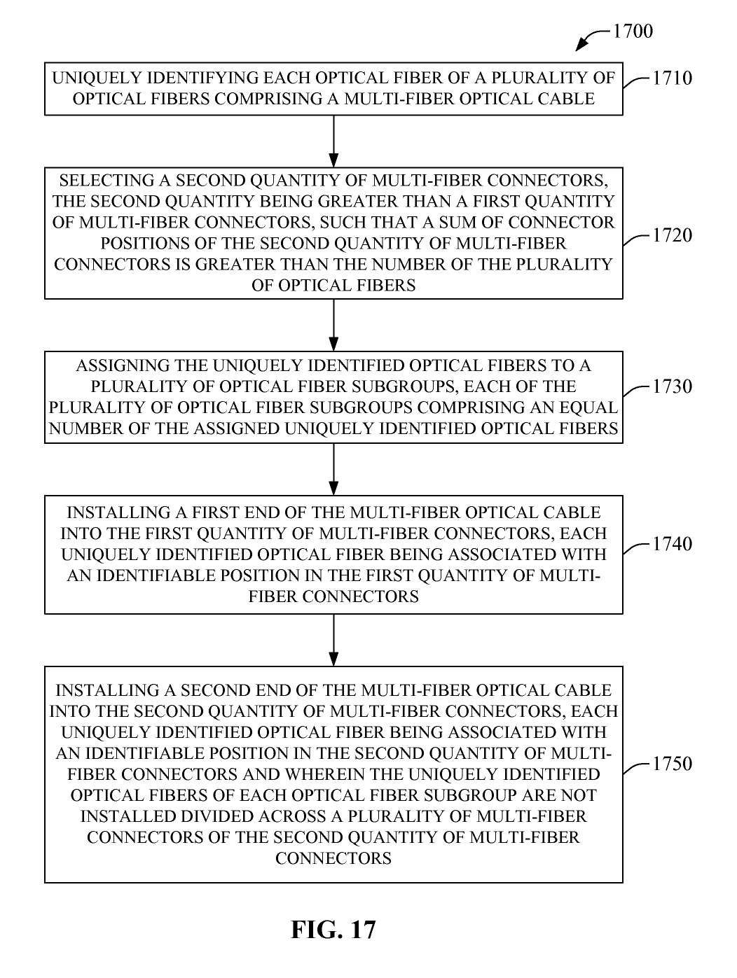

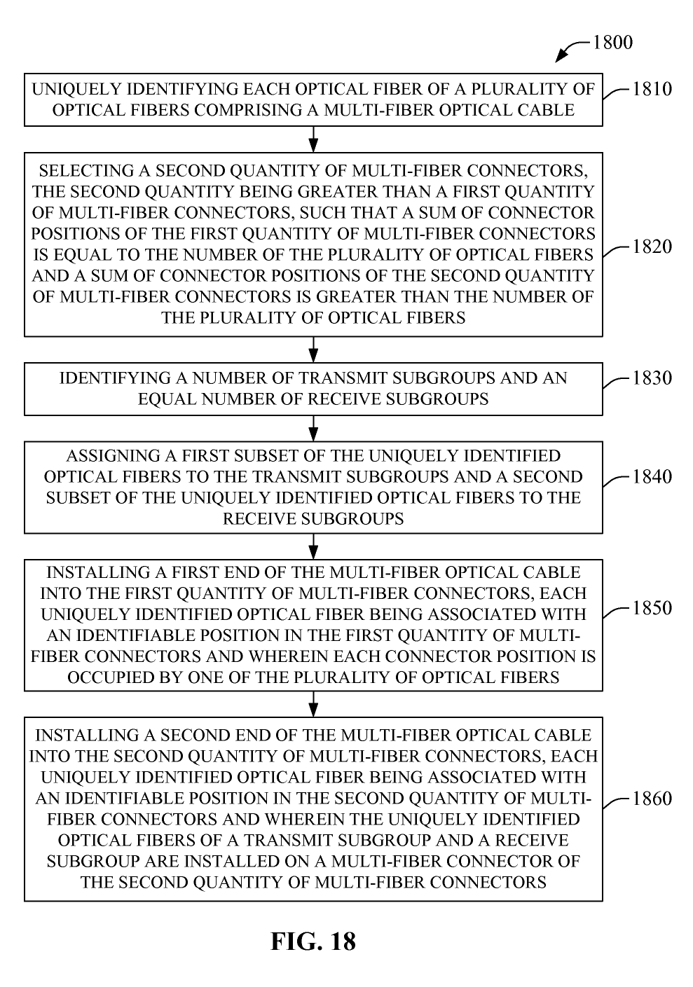

In view of the example system(s) described above, example method(s) that can be implemented in accordance with the disclosed subject matter can be better appreciated with reference to flowcharts in FIG. 17-FIG. 18. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 17 illustrates aspects of a method 1700 for assembling a fiber optic component in accordance with aspects of the subject disclosure. At 1710, the individual optical fibers of a plurality of optical fibers comprising a multi-fiber optical cable can be uniquely identified. As a non-limiting example, where optical fibers of an optical cable are color coded, colors can be employed to identify each individual optical fiber in the optical cable. As a second non-limiting example, where optical fibers are in fixed positions within the optical cable, position can be employed to identify optical fibers. It will be noted that other means of uniquely identifying optical fibers of an optical cable can be employed without departing from the scope of the present disclosure.

At 1720, two quantities of connectors can be selected in which optical fibers will be installed. A second quantity of connectors can be selected such that the second quantity exceeds a first quantity of connectors. Moreover, the sum of connector positions, e.g., optical paths, of the second quantity of connectors should be greater than the plurality of fibers of the optical cable from 1710. This can result in a condition in which there are empty positions when the fibers are installed in the second quantity of connectors.

At 1730, the identified optical fibers of the optical cable can be assigned to a plurality of optical fiber subgroups. The quantity of optical fibers in each subgroup should be the same. As an example, 24 optical fibers can be divided into two groups of 12 fibers, three groups of 8 fibers, 4 groups of 6 fibers, 6 groups of 4 fibers, etc.

At 1740, a first end of the optical cable can be installed in the first quantity of connectors. Each optical fiber of the first end can be associated with an identifiable position in the first quantity of connectors. As a non-limiting example, a 24 fiber optical cable can be installed into a single 24-path connector or into two 12-path connectors such that the position of each fiber in the connector is known.

At 1750, a second end of the optical cable can be installed into the second quantity of connectors. Each optical fiber of the second end can be associated with an identifiable position in the second quantity of connectors. Moreover, the groups assigned at 1730 are each installed on the same connector of the second quantity of connectors. At this point, method 1700 can end. As a non-limiting example, where six subgroups of 4 fibers are assigned at 1730 (e.g., 24 total fibers) and the second quantity of connectors is three 12-position connectors, then at 1750 a first and second subgroup can be installed on a first 12-position connector, a third and fourth subgroup can be installed on a second 12-position connector, and a fifth and sixth subgroup can be installed on a third 12-position connector. It would be outside of method 1700, for example, to install subgroup 4 partially on the second 12-position connector and partially on the third 12-position connector.

FIG. 18 illustrates aspects of a method 1800 for assembling a fiber optic component in accordance with aspects of the subject disclosure. At 1810, the individual optical fibers of a plurality of optical fibers comprising a multi-fiber optical cable can be uniquely identified. At 1820, two quantities of connectors can be selected in which optical fibers will be installed. A second quantity of connectors can be selected such that the second quantity exceeds a first quantity of connectors. Moreover, the sum of connector positions, e.g., optical paths, of the second quantity of connectors should be greater than the plurality of fibers of the optical cable from 1810 and the sum of connector positions of the first quantity of connectors should be the same as the plurality of fibers. This can result in a condition in which there are empty positions when the fibers are installed in the second quantity of connectors and no empty position in the first quantity of connectors.

At 1830, a number of transmit subgroups and an equal number of receive subgroups can be identified. These subgroups can represent transmit and receive channels in an optical network. At 1840, the identified optical fibers can be assigned to the transmit and receive subgroups.

At 1850, a first end of the optical cable can be installed in the first quantity of connectors. Each optical fiber of the first end can be associated with an identifiable position in the first quantity of connectors. As a non-limiting example, a 24 fiber optical cable can be installed into a single 24-path connector or into two 12-path connectors such that the position of each fiber in the connector is known.

At 1860, a second end of the optical cable can be installed into the second quantity of connectors. Each optical fiber of the second end can be associated with an identifiable position in the second quantity of connectors. Moreover, the transmit and receive groups assigned at 1840 can be installed on the connectors such that neither a transmit group nor a receive group is partially installed on two connectors of the second quantity of connectors. At this point, method 1800 can end.

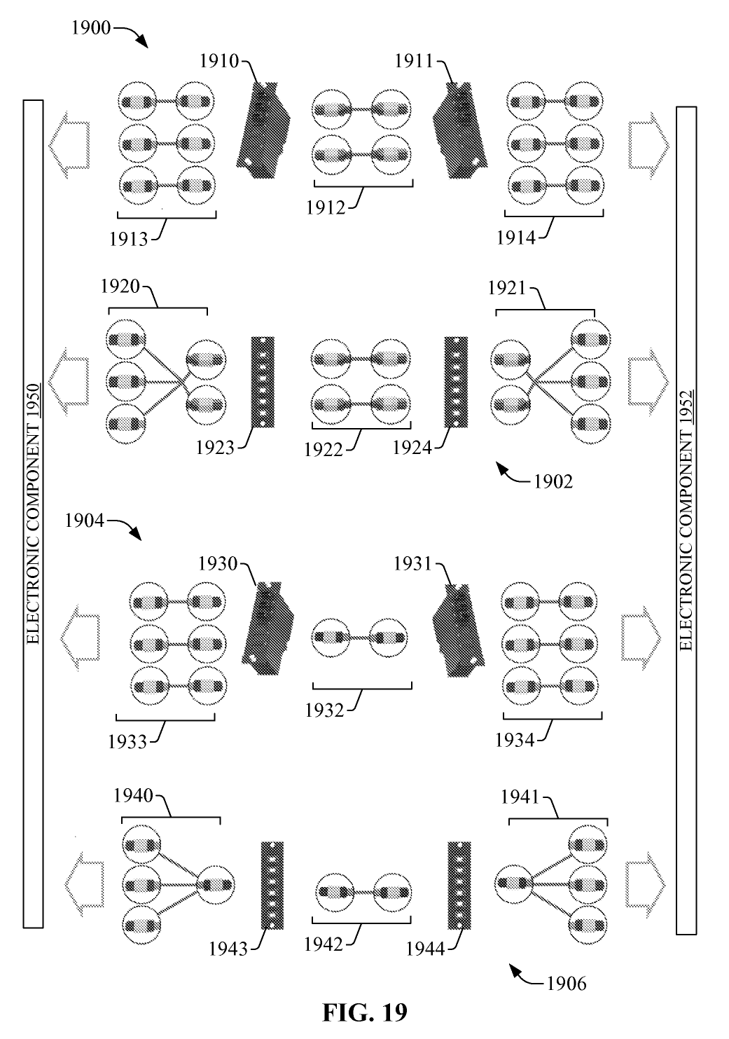

In order to provide a context for the various aspects of the disclosed subject matter, FIG. 19 presents exemplary embodiments 1900, 1902, 1904, and 1906 of optical systems that can implement and exploit one or more aspects of the subject matter described herein. Exemplary optical system 1900 can include MIMs 1910 and 1911, which can be interconnected by optical cable assemblies 1912. MIM 1910 can be optically connected to various components 1950, such as optical, optoelectronic, or electronic components, by way of optical cable assemblies 1913. Similarly, MIM 1911 can be optically connected to various components 1952, such as optical, optoelectronic, or electronic components, by way of optical cable assemblies 1914. As such, optical, optoelectronic, or electronic components 1950 and 1952 can be optically coupled by exemplary optical system 1900. Cable assemblies 1912, for example, can comprise 24 optical fibers in two 12-path cable assemblies. Cable assemblies 1913 and 1914, for example, can each comprise three 12-path cable assemblies. MIMs 1910 and 1911, in this example, can be 2×12/12 to 3×8/12 MIMs.

Similarly, in exemplary optical system 1902, optical cable assembly 1922 can comprise 24 optical fibers in two 12-path cable assemblies which can be coupled to MOCAs 1920 and 1921 by way of coupling plates 1923 and 1924, respectively. Coupling plates 1923 and 1924 can couple two 12-path connectors. In an aspect, an optical system can employ MOCA 1920 and coupling plate 1923 in place of MIM 1910 and cable assemblies 1913 from optical system 1900 to achieve the same connectivity. Similarly, MOCA 1921 and coupling plate 1924 can substitute for MIM 1911 and cable assemblies 1914. MOCAs 1920 and 1921, in this example, can be 2×12/12 to 3×8/12 MOCAs.

In exemplary optical system 1904, cable assembly 1932 can comprise 24 optical fibers. Cable assemblies 1933 and 1934 can each comprise three 12-path cable assemblies, similar to optical system 1900. MIMs 1930 and 1931 can therefore each be 1×24/24 to 3×8/12 MIMs.

Exemplary optical system 1906 can comprise a 24-path optical cable assembly 1942 and coupling plates 1943 and 1944. Coupling plates 1943 and 1944 can couple two 24-path connectors. Optical system 1906 can further comprise MOCAs 1940 and 1941 which, in this example, can each be 1×24/24 to 3×8/12 MOCAs.

In each exemplary optical system, e.g., 1900 to 1906, the interface with optical, optoelectronic, or electronic components 1950 and 1952 is by way of three partially populated 12-path optical connectors with could also be served by three fully populated 12-path optical connectors wherein a portion of the optical fibers are unused as disclosed hereinabove. The use of MIMs and MOCAs allows for the use of more dense optical connectors at 1912, 1922, 1932, and 1942, e.g., at the optical trunk cable position.

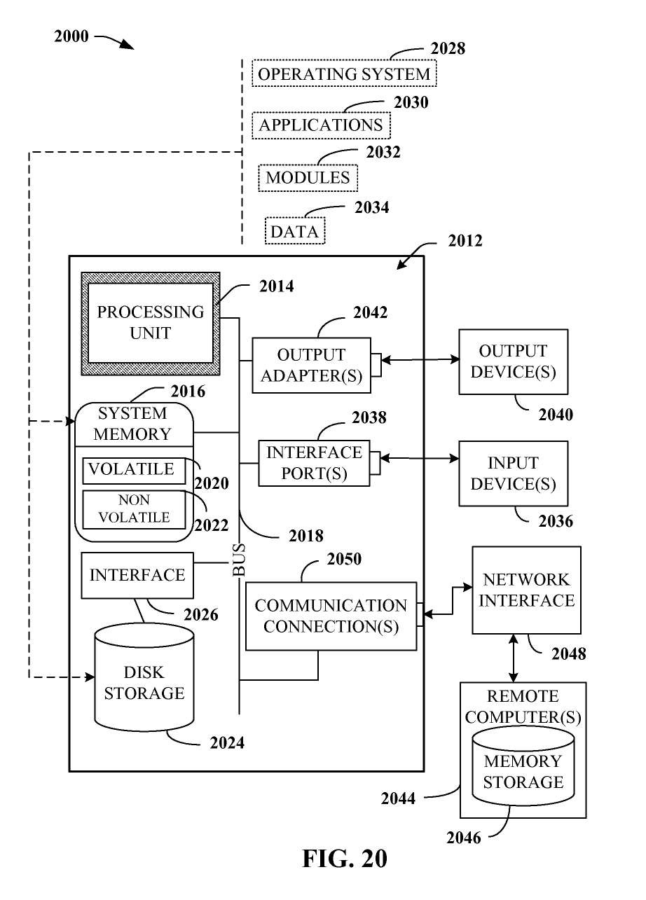

In order to provide further context for the various aspects of the disclosed subject matter, FIG. 20, and the following discussion, are intended to provide a brief, general description of a suitable environment in which the various aspects of the disclosed subject matter can be implemented. While some aspects of the subject matter have been described above in the general context of computer-executable instructions of a computer program that runs on a computer and/or computers, those skilled in the art will recognize that the disclosed subject matter can also be implemented in combination with other program modules. Generally, program modules include routines, programs, components, data structures, etc. that perform particular tasks and/or implement particular abstract data types.

FIG. 20 illustrates a block diagram of a computing system 2000 operable to execute the disclosed methods in accordance with an embodiment. Computer 2012 includes a processing unit 2014, a system memory 2016, and a system bus 2018. In an embodiment, computer 2012 can be all or part of the hardware comprising a multi-fiber cable assembly manufacturing component to facilitate production of MOCAs and/or MIMs as disclosed herein. System bus 2018 couples system components including, but not limited to, system memory 2016 to processing unit 2014. Processing unit 2014 can be any of various available processors. Dual microprocessors and other multiprocessor architectures also can be employed as processing unit 2014. Computer 2012 also includes removable/non-removable, volatile/non-volatile computer storage media, for example, disk storage 2024. To facilitate connection of the disk storage devices 2024 to system bus 2018, a removable or non-removable interface can be used, such as interface 2026.

Computing devices can include a variety of media, which can include computer-readable storage media or communications media, which two terms are used herein differently from one another as follows. Computer-readable storage media can be any available storage media that can be accessed by the computer and includes both volatile and nonvolatile media, removable and non-removable media. Communications media can embody computer-readable instructions, data structures, program modules, or other structured or unstructured data in a data signal such as a modulated data signal, e.g., a carrier wave or other transport mechanism, and includes any information delivery or transport media.

It can be noted that FIG. 20 describes software that acts as an intermediary between users and computer resources described in suitable operating environment 2000. Such software includes an operating system 2028. System applications 2030 take advantage of the management of resources by operating system 2028 through program modules 2032 and program data 2034 stored either in system memory 2016 or on disk storage 2024. It is to be noted that the disclosed subject matter can be implemented with various operating systems or combinations of operating systems.

A user can enter commands or information into computer 2012 through input device(s) 2036. These input devices can connect to processing unit 2014 through system bus 2018 by way of interface port(s) 2038. Output device(s) 2040 use some of the same type of ports as input device(s) 2036. As an example, a USB port can be used to provide input to computer 2012 and to output information from computer 2012 to an output device 2040. Output adapter 2042 is provided to illustrate that there are some output devices 2040 which use special adapters. It should be noted that other devices and/or systems of devices provide both input and output capabilities such as remote computer(s) 2044. In an embodiment, a computer vision system including a color camera input device, can be operable to facilitate identification of optical fibers according to the methods disclosed herein. In a further embodiment, an output device can be an automated fiber installation tool that receives installation instructions according to the methods disclosed herein from processing unit 2014 to perform installation of optical fibers in connectors. Computer 2012 can operate in a networked environment using logical connections to one or more remote computers, such as remote computer(s) 2044. For purposes of brevity, only a memory storage device 2046 is illustrated with remote computer(s) 2044. Remote computer(s) 2044 can be logically connected to computer 2012 through a network interface 2048 and then physically connected by way of communication connection 2050.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A fiber optic cable assembly, comprising:
a multi-fiber optical cable comprising optical fibers, the optical fibers further comprising a plurality of logical channels, wherein each logical channel of the plurality of logical channels comprises at least four optical fibers;
at least a first multi-fiber optical connector having installed therein the optical fibers comprising at least one logical channel of the plurality of logical channels from a first end of the multi-fiber optical cable; and
a plurality of multi-fiber optical connectors, each multi-fiber optical connector of the plurality of multi-fiber optical conductors having installed therein the optical fibers comprising at least one logical channel of the plurality of logical channels from a second end of the multi-fiber optical cable.

2. The fiber optic cable assembly of claim 1, wherein the multi-fiber optical cable comprises six logical channels and the at least a first multi-fiber optical connector has installed therein the optical fibers comprising the six logical channels.

3. The fiber optic cable assembly of claim 2, wherein the at least a first multi-fiber optical connector comprises 24 optical paths arranged in two rows of 12 optical paths, each path having disposed therein an installed optical fiber.

4. The fiber optic cable assembly of claim 1, further comprising a second multi-fiber optical connector having installed therein the optical fibers comprising at least one logical channel of the plurality of logical channels from a first end of the multi-fiber optical cable.

5. The fiber optic cable assembly of claim 4, wherein the multi-fiber optical cable comprises six logical channels, the at least a first multi-fiber optical connector has installed therein the optical fibers comprising three of the six logical channels, and the second multi-fiber optical connector has installed therein the optical fibers comprising the remaining three of the six logical channels.

6. The fiber optic cable assembly of claim 5, wherein the at least a first multi-fiber optical connector comprises 12 optical paths arranged in one row of 12 optical paths, each path having disposed therein an installed optical fiber, and the second multi-fiber optical connector comprises 12 optical paths arranged in one row of 12 optical paths, each path having disposed therein an installed optical fiber.

7. The fiber optic cable assembly of claim 1, wherein each multi-fiber optical connector of the plurality of multi-fiber optical conductors comprises at least one optical path that does not have an optical fiber installed therein.

8. The fiber optic cable assembly of claim 7, wherein the multi-fiber optical cable comprises six logical channels and each multi-fiber optical connector of the plurality of multi-fiber optical conductors has installed therein the optical fibers for two logical channels such that the plurality of multi-fiber optical conductors comprises three multi-fiber optical connectors.

9. The fiber optic cable assembly of claim 8, wherein each multi-fiber optical connector of the plurality of multi-fiber optical conductors comprises 12 optical paths arranged in one row of 12 optical paths having positions 1-12 and the optical fibers comprising the first of the two logical channels installed thereon are disposed in optical paths 1-4 and the second of the two logical channels installed thereon are disposed in optical paths 9-12, such that optical paths 5-8 remain empty.

10. A multi-fiber interconnection module, comprising:
a plurality of optical fibers, the plurality of optical fibers associated with a plurality of logical channels, wherein each logical channel of the plurality of logical channels comprises at least four of the optical fibers;
at least a first multi-fiber optical connector having installed therein a first end of the optical fibers associated with at least one logical channel of the plurality of logical channels; and
a plurality of multi-fiber optical connectors, each multi-fiber optical connector of the plurality of multi-fiber optical conductors having installed therein a second end of the optical fibers associated with at least one other logical channel of the plurality of logical channels.

11. The multi-fiber interconnection module of claim 10, wherein the plurality of logical channels comprises six logical channels and the at least a first multi-fiber optical connector has installed therein the optical fibers associated with the six logical channels.

12. The multi-fiber interconnection module of claim 11, wherein the at least a first multi-fiber optical connector comprises 24 optical paths arranged in two rows of 12 optical paths, each path having disposed therein an installed optical fiber.

13. The multi-fiber interconnection module of claim 10, further comprising a second multi-fiber optical connector having installed therein a first end the optical fibers associated with at least one logical channel.

14. The multi-fiber interconnection module of claim 13, wherein the at least a first multi-fiber optical connector has installed therein the optical fibers associated with three logical channels and the second multi-fiber optical connector has installed therein the optical fibers associated with three other logical channels.

15. The multi-fiber interconnection module of claim 14, wherein the at least a first multi-fiber optical connector comprises 12 optical paths arranged in one row of 12 optical paths, each path having disposed therein an installed optical fiber, and the second multi-fiber optical connector comprises 12 optical paths arranged in one row of 12 optical paths, each path having disposed therein an installed optical fiber.

16. The multi-fiber interconnection module of claim 10, wherein each multi-fiber optical connector of the plurality of multi-fiber optical conductors comprises at least one optical path that does not have an optical fiber installed therein.

17. The multi-fiber interconnection module of claim 16, wherein each multi-fiber optical connector of the plurality of multi-fiber optical conductors comprises 12 optical paths arranged in one row of 12 optical paths having positions 1-12 and the optical fibers associated with a first of two logical channels installed thereon are disposed in optical paths 1-4 and optical fibers associated with a second of two logical channels installed thereon are disposed in optical paths 9-12, optical paths 5-8 remaining empty.

18. The multi-fiber interconnection module of claim 10, wherein the multi-fiber interconnection module is a walled enclosure-type or a cast-type.

19. A method, comprising:
identifying each of a plurality of optical fibers, the plurality of optical fibers comprising a plurality of channels, each channel of the plurality of channels comprising four optical fibers;
selecting a first quantity of multi-fiber optical connectors in which to install a first end of the plurality of optical fibers, wherein the sum of the optical paths of the first quantity of multi-fiber optical connectors is equal to the plurality of optical fibers;
selecting a second quantity of multi-fiber optical connectors in which to install a second end of the plurality of optical fibers, wherein the sum of the optical paths of the second quantity of multi-fiber optical connectors is greater than the plurality of optical fibers;
installing the first end of the optical fibers of a channel as a group in one of the first quantity of multi-fiber optical connectors; and
installing the second end of the optical fibers of at least one channel as a group in one of the second quantity of multi-fiber optical connectors.

20. The method of claim 19, further comprising designating a first portion of the plurality of channels as transmit channels and an equal portion of the plurality of channels as receive channels and wherein installing the second end of the optical fibers results in each multi-fiber optical connector of the second quantity of multi-fiber optical connectors having installed therein at least one transmit channel and at least one receive channel.

21. The method of claim 20, wherein installing the second end of the optical fibers results in each multi-fiber optical connector of the second quantity of multi-fiber optical connectors having at least one empty optical paths.

22. A system comprising:
a plurality of optical fibers, the plurality of optical fibers associated with a plurality of logical channels, wherein each logical channel of the plurality of logical channels comprises at least four of the optical fibers;
at least a first multi-fiber optical connector having installed therein the optical fibers from a first end of the multi-fiber optical cable; and
a plurality of multi-fiber optical connectors, each multi-fiber optical connector of the plurality of multi-fiber optical conductors having installed therein the optical fibers comprising at least two logical channels of the plurality of logical channels from a second end of the multi-fiber optical cable.

23. The system of claim 22, wherein:
the at least a first multi-fiber optical connector is a 24-path multi-fiber optical connector or two 12-path multi-fiber optical connector; and
the plurality of multi-fiber optical connectors is three 12-path multi-fiber optical connectors.

24. The system of claim 23, comprising a fiber optic cable assembly or comprising a multi-fiber interconnection module.

25. The system of claim 23, wherein the plurality of optical fibers is installed in the at least a first multi-fiber optical connector and the plurality of multi-fiber optical connectors in accord with one of Tables 4-11.
